(19) United States
(12) Patent Application Publication
(10) Pub. No.: US 2026/0289729 A1
(43) Pub. Date: Sep. 24, 2026

(54) JOINT PROCESSING OF FOVEATED STREAMS

(71) Applicant: QUALCOMM Incorporated, San Diego, CA (US)

(72) Inventors: Shrey Shailesh GADIYA, Bengaluru (IN); Amrit Anand AMRESH, Bangalore (IN); Praveen SEKAR, Bangalore (IN); Krishna MOHAN, Bangalore (IN); Yash GUPTA, Ambala (IN)

(21) Appl. No.: 19/085,921

(22) Filed: Mar. 20, 2025

(51) Int. Cl. G06T 5/50; G06T 3/18; G06T 5/20; G06T 7/11; G06V 10/24

(52) U.S. Cl. CPC G06T 5/50; G06T 3/18; G06T 5/20; G06T 7/11; G06V 10/24; G06T 2207/20221

(57) ABSTRACT

This disclosure provides systems, devices, apparatus, and methods, including computer programs encoded on storage media, for joint processing of foveated streams. A display processor may obtain a first portion of image data at a first resolution, the first portion corresponding to a first FOV and a second portion of the image data at a second resolution that is lower than the first resolution, the second portion of the image data corresponding to a second FOV that is larger than, and includes, the first FOV. The display processor may determine a first filtered output for the first FOV at the first resolution and a second filtered output for the second FOV at the second resolution by filtering the first and second portions of the image data together. The display processor may output blended image data based on the first and second filtered outputs.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for display processing may utilize spatio-temporal filtering for alignment and warping in fields of view (FOVs) corresponding to eye-gaze changes between image frames, but may not address resource usage, such as for calls to non-real time (NRT) cores, as well as alignment and invalid pixel issues for spatio-temporal filtering. There is a need for improved techniques for spatio-temporal filtering associated with of fovea and mid-fovea regions during eye-gaze changes.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain a first portion of image data at a first resolution, the first portion corresponding to a first FOV, to obtain a second portion of the image data at a second resolution that is lower than the first resolution, the second portion of the image data corresponding to a second FOV, where the second FOV is larger than the first FOV and comprises the first FOV, to determine a first filtered output corresponding to the first FOV at the first resolution by filtering the first portion of the image data together with the second portion of the image data, to determine a second filtered output corresponding to the second FOV at the second resolution by filtering the second portion of the image data together with the first portion of the image data, and to output blended image data based on the first filtered output and the second filtered output.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 illustrates examples of eye-gaze regions and foveated image content in accordance with one or more techniques of this disclosure.

FIG. 5 illustrates an example of end-to-end (E2E) processing for a sensor stream in accordance with one or more techniques of this disclosure.

FIG. 6 illustrates an example of spatio-temporal filtering for foveated image frames in accordance with one or more techniques of this disclosure.

FIG. 7 illustrates an example of spatio-temporal filtering for joint processing of foveated streams in accordance with one or more techniques of this disclosure.

FIG. 8 illustrates an example of warping and alignment for joint processing of foveated streams in accordance with one or more techniques of this disclosure.

FIG. 9 illustrates an example of warping and alignment for joint processing of foveated streams in accordance with one or more techniques of this disclosure.

FIG. 10 illustrates an example of warping and alignment for joint processing of foveated streams in accordance with one or more techniques of this disclosure.

FIG. 11 illustrates examples of fovea margins and tile-based joint processing of foveated streams in accordance with one or more techniques of this disclosure.

FIG. 12 is a call flow diagram illustrating example communications between a display processor and a display panel in accordance with one or more techniques of this disclosure.

FIG. 13 is a flowchart of an example method of display processing in accordance with one or more techniques of this disclosure.

FIG. 14 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, instances of the term “field of view” and/or “FOV” may refer to a region associated with the focus and eye-gaze of a user, such as types of fovea regions, periphery regions, etc. As used herein, instances of the term “region of interest” and/or “ROI” may refer to regions of an image or image frame one which a user's eye-gaze is focused. As used herein, instances of the term “foveation sensor” may refer to a sensor configured to identify/determine and/or take as an input an ROI(s) associated with an image frame and determine FOVs, and locations thereof, with associated resolutions that correspond to the ROI(s). As used herein, instances of the term “sensor stream” may refer to a processing pipeline including of a foveation sensor, a front-end engine for inline processing of images/image frames, spatio-temporal filtering, and post processing (e.g., image processing for tone, color, sharpness, and/or the like). As used herein, instances of the terms “non-real time core” and/or “NRT core” may refer to processing cores that are configured to perform processing and/or filtering associated with data that is not in real time, such as prior image frames. As used herein, instances of the term “warping” may refer to a perspective transform, or an advanced alignment such as optical flow based warping for local motion, of image content with respect to a reference frame. As used herein, instances of the term “frame n” may refer to a current image frame of image content, and instances of the term “frame n-1” may refer to a prior or immediately prior image frame (e.g., a “reference frame”) of the image content. As used herein, instances of the term “warping domain” may refer to the scale and offset (e.g., translational) at which the warping operation (e.g., coordinate interpolation) will be performed.

Human beings see more details near a focal point, and sensitivity to perceive details drops radially while moving away from the focal point. Accordingly, foveation techniques, such as utilizing foveation sensors, may be used to generate outputs corresponding to different resolutions for different regions or FOVs related to focus in an image. Each image frame may include a set of ROIs, and each ROI may have its own unique FOV and/or resolution. In some cases, ROI size may change dynamically from frame to frame. As an example, a fovea region may include a relatively small FOV at a full/1:1 resolution (e.g., without downscaling), a middle/intermediate region may include a medium-sized FOV at a DS2 (downscaled by 2) resolution, and a periphery region may include a full FOV at a DS4 (downscaled by 4) resolution. In such cases, there may be no holes in the middle and periphery regions (e.g., higher resolution regions may be overlaid on lower resolution regions), and as a result, a middle region may also contain the fovea FOV, but in the DS2 resolution, while the periphery region may also contain the middle and the fovea FOVs, but in the DS4 resolution. In E2E processing for a sensor stream, a foveation sensor may perform or execute spatio-temporal filtering or processing for each region/FOV, including warping and alignment. Some examples provide for such spatio-temporal filtering to be performed independently for each region/FOV. Such handling includes high numbers of invocations or calls to NRT cores. As one example, spatio-temporal filtering performed independently for each of a fovea FOV, a mid-fovea FOV, and a periphery FOV would invoke or call three NRT core instances. Additionally, higher numbers of NRT core invocations are associated with higher bandwidth utilization of display processors. Further, example warping and alignment techniques for spatio-temporal filtering may result in high numbers of invalid pixels for fovea FOV changes when a user's eye-gaze moves rapidly between image frames.

Aspects herein provide for joint processing of foveated streams, e.g., such as via NRT cores. Aspects enable to organization of foveated streams such that redundant processes do not happen. In particular, the architecture provides for three fovea levels with three filtering passes. There are two identified challenges to implementing this more efficient solution. First, a fovea region/FOV change can cause alignment issues even if there is no global motion and object(s) in the fovea region/FOV remain static. The aspects herein provide for handling the fovea change alignment using the full FOV alignment as the full FOV alignment already has that data for alignment. Second, there will be missing data after the realignment based on the fovea region/FOV change. The aspects herein provide for an increased margin (e.g., margin region) for the fovea region/FOV. A maximum size may be provided for this increased margin based on the maximum amount of distance the fovea can change (e.g., based on eye-gaze changes over time and/or per image frame), and this margin can be adjusted per device type/manufacturer, per scenario/use case, etc., based on considerations such as performance, power, noise-tolerance, and/or the like. An additional enhancement provided by aspects herein is a tiling strategy for joint processing of foveated streams to allow underlying tiles to be ready before the overlying tiles to enable a more efficient approach.

Accordingly, aspects provide for reduced numbers of invocations for spatio-temporal filtering blocks, e.g., NRT cores, by joint processing of the fovea and periphery streams that leverage commonalities in foveated stream processing. Corresponding warping techniques allow for maintaining the full FOV transformations instead of maintaining transformations for each stream. As one example, aspects enable multi-level passes for spatio-temporal filtering to be scheduled such that DS4 (downscaled by 4) and DS16 (downscaled by 16) passes for fovea FOVs may be taken from periphery FOV streams of the foveation sensor, and a second-pass output of the periphery FOV for spatio-temporal filtering may be tapped off for post processing to reduce invocations of NRT cores. Aspects provide for alignments via offsets associated with current and prior image frames to be coupled to warping operations. Aspects additional enable margins (e.g., margin regions) for fovea FOVs to reduce or eliminate invalid pixels during spatio-temporal filtering. Aspects are also extensible for the utilization of NRT cores with tile-/stripe-based processing (e.g., for low latency) to advantageously use known FOV information for other FOVs. Based on the aspects noted herein, processing time, bandwidth, and power usage are reduced, as is firmware utilization.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

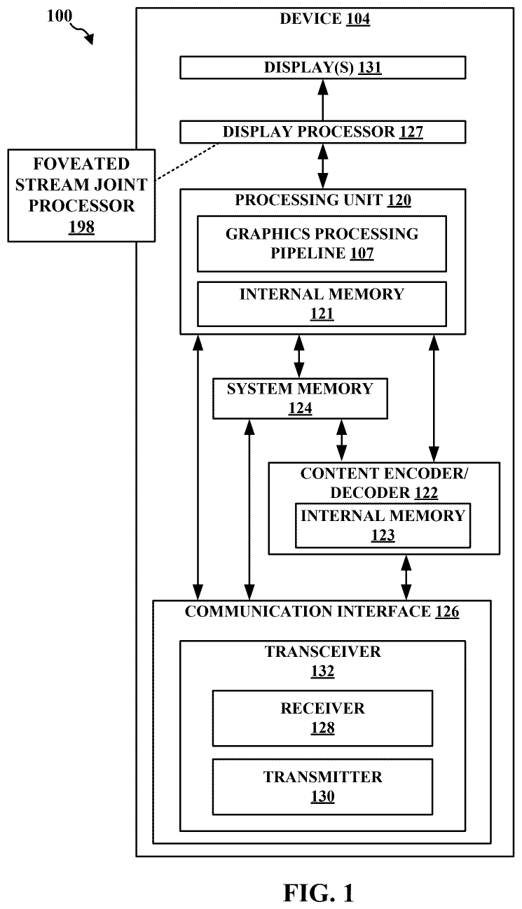

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a foveated stream joint processor 198 configured to obtain a first portion of image data at a first resolution, the first portion corresponding to a first FOV, obtain a second portion of the image data at a second resolution that is lower than the first resolution, the second portion of the image data corresponding to a second FOV, where the second FOV is larger than the first FOV and comprises the first FOV, determine a first filtered output corresponding to the first FOV at the first resolution by filtering the first portion of the image data together with the second portion of the image data, determine a second filtered output corresponding to the second FOV at the second resolution by filtering the second portion of the image data together with the first portion of the image data, and output blended image data based on the first filtered output and the second filtered output. The foveated stream joint processor 198 may be further configured to obtain a third portion of the image data at a third resolution that is lower than the first resolution and the second resolution, the third portion of the image data corresponding to the second FOV. The foveated stream joint processor 198 may be further configured to obtain a fourth portion of the image data at a third resolution that is lower than the first resolution and higher than the second resolution, the fourth portion of the image data corresponding to a third FOV, where the third FOV is larger than the first FOV and comprises the first FOV and where the second FOV is larger than the third FOV and comprises the third FOV, obtain a fifth portion of the image data at a fourth resolution that is lower than the second resolution, the fifth portion of the image data corresponding to the second FOV, and determine a third filtered output corresponding to the third FOV at the third resolution by filtering the fourth portion of the image data and the fifth portion of the image data together. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

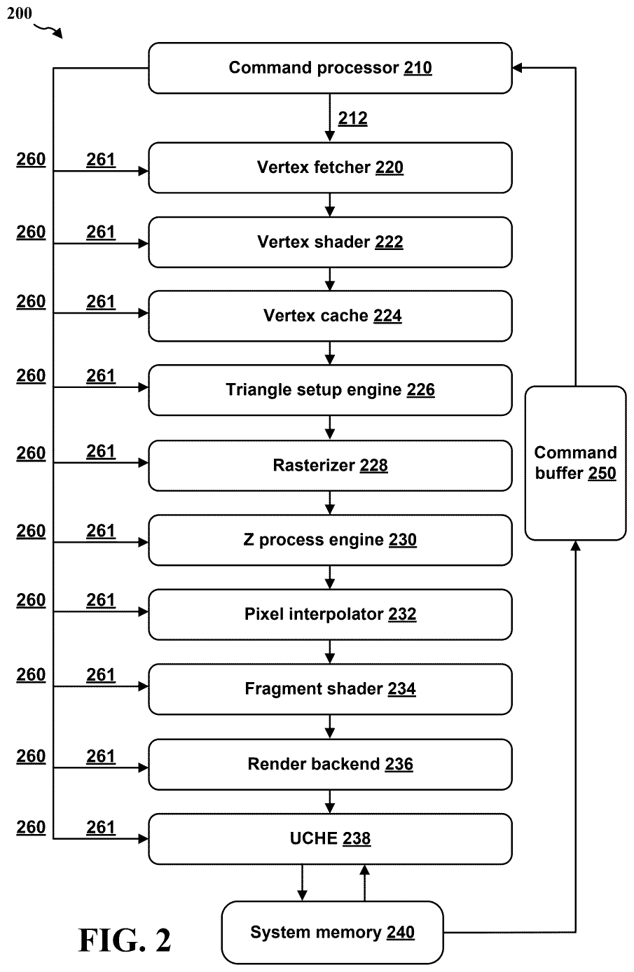

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

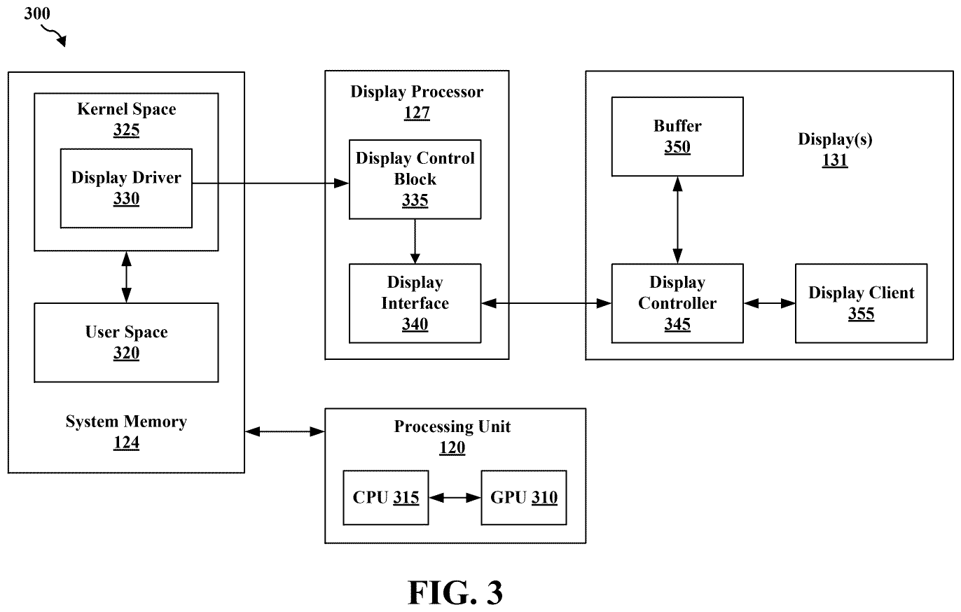

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

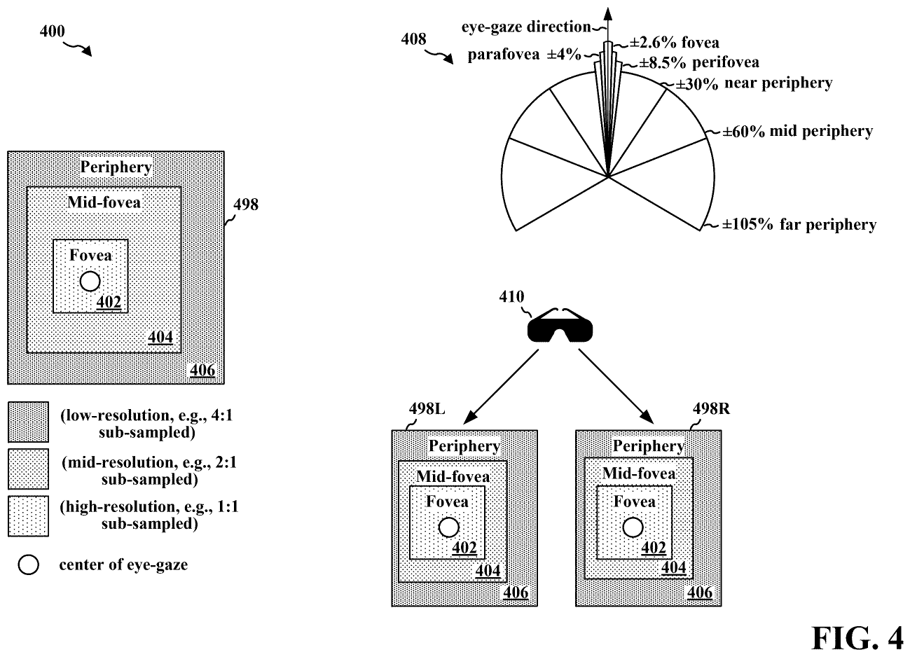

FIG. 4 illustrates a diagram 400 for eye-gaze regions and foveated image content in accordance with one or more techniques of this disclosure. As noted above, humans see more details near a focal point, and sensitivity to perceive details drops radially while moving away from the focal point, such as a fovea FOV 402. An example of this detail attenuation is shown by a focal example 408. The fovea FOV 402 (e.g., a small FOV) is shown with a full or 1:1 resolution and no downscaling, for an image frame 498 comprise of image data. Image frame 498 also includes a mid-fovea FOV 404 (e.g., a medium FOV) at DS2 resolution and a periphery FOV 406 (e.g., a full FOV) at DS4 resolution, by way of example. A head mounted device (HMD) 410 or the like may display image content to a user, e.g., for an application such as an extended reality (XR) application, in which a left-eye view 498L and a right-eye view 498R of the image frame 498 are provided.

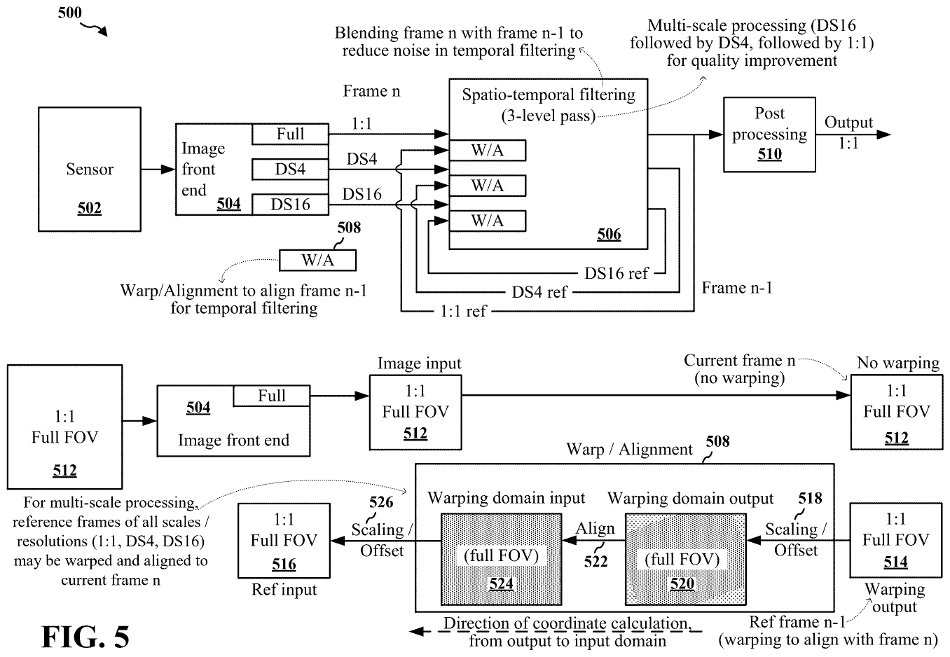

FIG. 5 illustrates a diagram 500 for E2E processing for a sensor stream in accordance with one or more techniques of this disclosure. Subsequent to operation of a fovea sensor 502, as described herein, image data for an image frame (e.g., a current image frame n) may be provided to an image front end 504 for inline processing of the current image frame n (e.g., downscaling). The image front end 504 may provide full resolution (e.g., 1:1), DS4 resolution, and DS16 resolution representations of the current image frame n for spatio-temporal filtering 506 (e.g., via invocation of an NRT core). The spatio-temporal filtering 506 may be multi-pass for image quality improvement, as shown by way of example for 3-pass filtering (e.g., based on the 1:1, DS4, and DS16 resolutions, although additional passes are enabled by aspects), and may follow a memory hop (not shown for illustrative clarity and brevity of description). The scales of the spatio-temporal filtering 506 for multi-pass may be any ratio, and are shown by way of example as 1:1, DS4, and DS16 scales, but may also applies to other examples, such as but without limitation, 1:1, DS2, and DS4, etc.). The spatio-temporal filtering 506 may blend frame n with frame n-1 to reduce noise in the filtering.

For each pass, the spatio-temporal filtering 506 may use its previous output, shown by the feedback/reference inputs shown. Such reference inputs may pass through a warp/alignment block 508 (W/A”). As one example, instances of the warp/alignment block 508 may receive outputs of the spatio-temporal filtering 506 as reference frames, also prior frames n-1, such as a 1:1 reference frame, a DS4 reference frame, and a DS16 reference frame, for filtering of the current image frame n. The warp/alignment block 508 may be configured to align frame n-1 with frame n for the spatio-temporal filtering 506. The instance of the current image frame n at 1:1 resolution may be output by the spatio-temporal filtering 506 for post processing 510 (e.g., image processing for tone, color, sharpness, and/or the like), after which, the filtered output may be merged with other filtered outputs for different FOVs to generate blended image data.

With reference to the warp/alignment block 508, the reference image or the previous output image (e.g., frame n-1) may be received and warped to align it to the current frame (e.g., frame n) for performing the spatio-temporal filtering 506. A full FOV image frame representation 512 of the current image frame n may be provided to the image front end 504 as an input image frame that is not warped by the warp/alignment block 508. With reference to a full FOV representation 514 (e.g., at 1:1 resolution), by way of example while full FOV DS4 and DS16 representations are also applicable, for each output pixel, a coordinate in the warping domain output for the full FOV representation 514 (e.g., at 1:1 resolution) may be calculated by a scaling and offset 518 as appropriate to generate a reference representation 520. A main alignment 522 (e.g., global and/or local) may be performed on the reference representation 520 in a warping domain (e.g., input/output warping domains) to generate an aligned reference representation 524, and the coordinates in the input image may be calculated from the warping input domain by a second set of scaling and offsets 526 configuration to generate the reference input 516 for the prior frame n-1 at the DS4 resolution and for the full FOV.

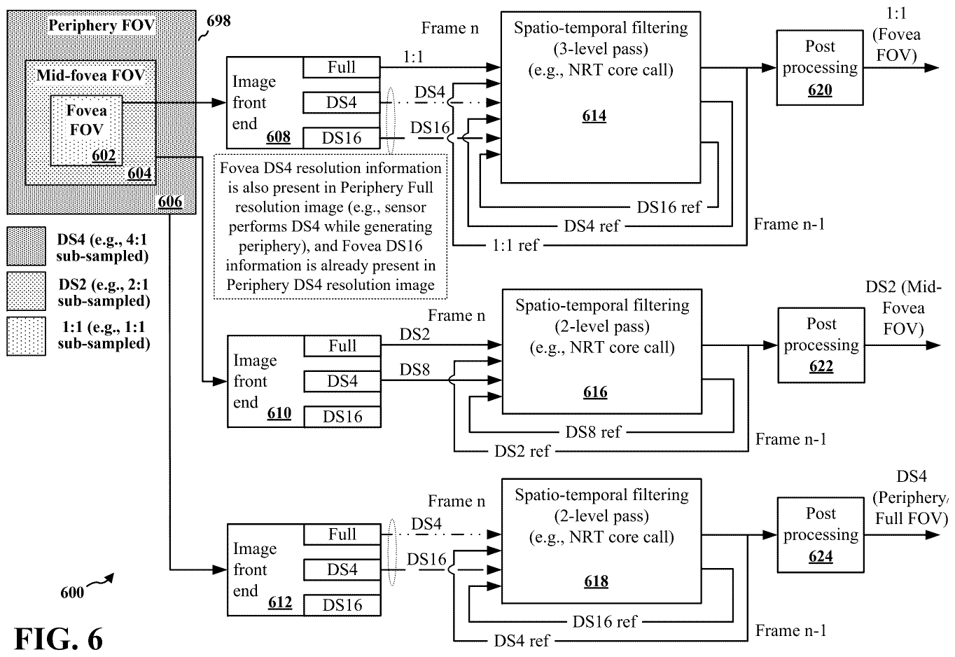

FIG. 6 illustrates a diagram 600 for spatio-temporal filtering for foveated image frames in accordance with one or more techniques of this disclosure. Diagram 600 may be an aspect of diagram 500 in FIG. 5 as applied to three invocations of an NRT core for three FOVs (e.g., a fovea FOV 602, a mid-fovea FOV 604, and a periphery FOV 606 of an image frame 698. Subsequent to operation of a fovea sensor, as described herein, image data for the image frame 698 (e.g., a current image frame n) may be provided for spatio-temporal filtering.

For example, image data associated with the fovea FOV 602 for the image frame 698 (e.g., the current image frame n) may be provided to an image front end 608 for inline processing of the current image frame n (e.g., downscaling). The image front end 608 may provide full resolution (e.g., 1:1), DS4 resolution, and DS16 resolution representations of the current image frame n for spatio-temporal filtering 614 (e.g., via a first invocation of an NRT core). The spatio-temporal filtering 614 may be multi-pass for image quality improvement, as shown by way of example for 3-pass filtering (e.g., based on the 1:1, DS4, and DS16 resolutions, although additional passes are enabled by aspects). The spatio-temporal filtering 614 may blend frame n, for the image frame 698, with a prior image frame n-1 to reduce noise in the filtering. For each pass, the spatio-temporal filtering 614 may use its previous output, shown by the feedback/reference inputs shown. Such reference inputs may pass through a warp/alignment block, as described herein, such as for FIG. 5. As one example, instances of such a warp/alignment block may receive outputs of the spatio-temporal filtering 614 as reference frames, also prior frames n-1, such as a 1:1 reference frame, a DS4 reference frame, and a DS16 reference frame, for filtering of the current image frame n. The warp/alignment block(s) may be configured to align frame n-1 with frame n for the spatio-temporal filtering 614. The instance of the current image frame n at 1:1 resolution may be output by the spatio-temporal filtering 614 for post processing 620 (e.g., image processing for tone, color, sharpness, and/or the like), after which, the filtered output for the fovea FOV may be merged with other filtered outputs for different FOVs to generate blended image data.

Image data associated with the mid-fovea FOV 604 for the image frame 698 (e.g., the current image frame n) may be provided to an image front end 610 for inline processing of the current image frame n (e.g., downscaling). The image front end 610 may provide DS2 resolution and DS8 (downscaled by 8) resolution representations of the current image frame n for spatio-temporal filtering 616 (e.g., via a second invocation of an NRT core). The spatio-temporal filtering 616 may be multi-pass for image quality improvement, as shown by way of example for 2-pass filtering (e.g., based on the DS2 and DS8 resolutions, although additional passes are enabled by aspects). The spatio-temporal filtering 616 may blend frame n, for the image frame 698, with a prior image frame n-1 to reduce noise in the filtering. For each pass, the spatio-temporal filtering 616 may use its previous output, shown by the feedback/reference inputs shown. Such reference inputs may pass through a warp/alignment block, as described herein, such as for FIG. 5. As one example, instances of such a warp/alignment block may receive outputs of the spatio-temporal filtering 616 as reference frames, also prior frames n-1, such as a DS2 reference frame and a DS8 reference frame, for filtering of the current image frame n. The warp/alignment block(s) may be configured to align frame n-1 with frame n for the spatio-temporal filtering 616. The instance of the current image frame n at DS2 resolution may be output by the spatio-temporal filtering 616 for post processing 622 (e.g., image processing for tone, color, sharpness, and/or the like), after which, the filtered output for the mid-fovea FOV may be merged with other filtered outputs for different FOVs (e.g., the fovea FOV) to generate blended image data.

Image data associated with the periphery FOV 606 for the image frame 698 (e.g., the current image frame n) may be provided to an image front end 612 for inline processing of the current image frame n (e.g., downscaling). The image front end 612 may provide DS4 resolution and DS16 resolution representations of the current image frame n for spatio-temporal filtering 618 (e.g., via a third invocation of an NRT core). The spatio-temporal filtering 618 may be multi-pass for image quality improvement, as shown by way of example for 2-pass filtering (e.g., based on the DS4 and DS16 resolutions, although additional passes are enabled by aspects). The spatio-temporal filtering 618 may blend frame n, for the image frame 698, with a prior image frame n-1 to reduce noise in the filtering. For each pass, the spatio-temporal filtering 618 may use its previous output, shown by the feedback/reference inputs shown. Such reference inputs may pass through a warp/alignment block, as described herein, such as for FIG. 5. As one example, instances of such a warp/alignment block may receive outputs of the spatio-temporal filtering 618 as reference frames, also prior frames n-1, such as a DS4 reference frame and a DS16 reference frame, for filtering of the current image frame n. The warp/alignment block(s) may be configured to align frame n-1with frame n for the spatio-temporal filtering 618. The instance of the current image frame n at DS4 resolution may be output by the spatio-temporal filtering 618 for post processing 624 (e.g., image processing for tone, color, sharpness, and/or the like), after which, the filtered output for the periphery/full FOV may be merged with other filtered outputs for different FOVs (e.g., the fovea FOV and/or the mid-fovea FOV) to generate blended image data.

However, independent handling of each foveated stream/FOV handling includes high numbers of invocations or calls to NRT cores. As one example, spatio-temporal filtering performed independently for each of the fovea FOV 602, the mid-fovea FOV 604, and the periphery FOV 606 invoke or call three NRT core instances. Additionally, higher numbers of NRT core invocations are associated with higher bandwidth utilization of display processors. As illustrative, the DS4 resolution information is present as an output of the image front end 608 for the fovea FOV 602 as well as the image front end 612 for the periphery FOV 606. Likewise, the DS16 resolution information is present as an output of the image front end 608 for the fovea FOV 602 as well as the image front end 612 for the periphery FOV 606. Further, example warping and alignment techniques for spatio-temporal filtering may result in high numbers of invalid pixels for fovea FOV changes when a user's eye-gaze moves rapidly between image frames.

Aspects herein for joint processing of foveated streams, e.g., as described below, optimize spatio-temporal filtering to reduce/eliminate the issues noted above.

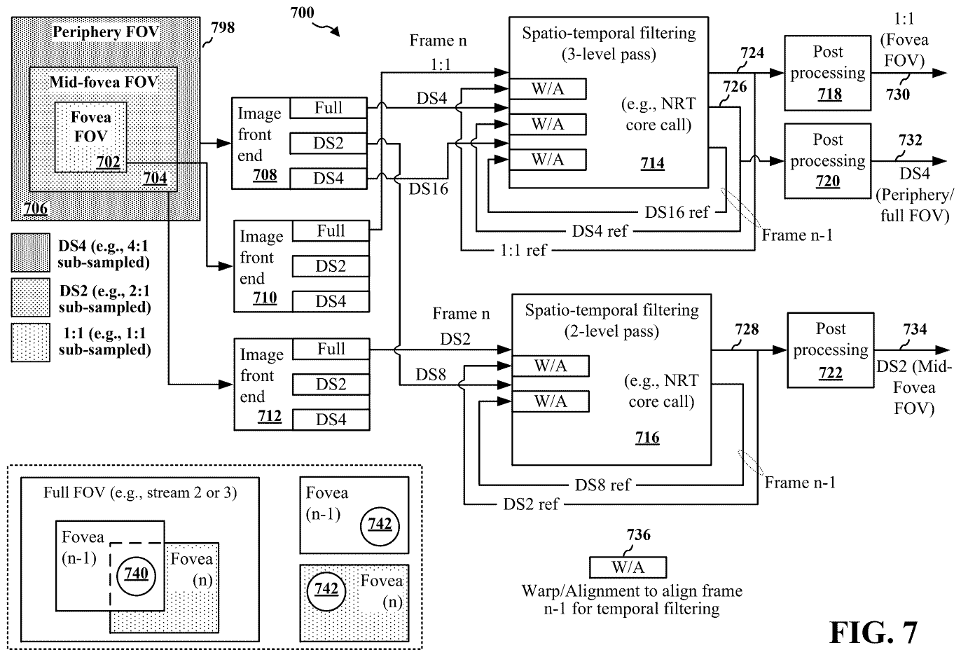

FIG. 7 illustrates a diagram 700 for spatio-temporal filtering for joint processing of foveated streams in accordance with one or more techniques of this disclosure. Diagram 700 shows joint processing of foveated streams for three FOVs (e.g., a fovea FOV 702, a mid-fovea FOV 704, and a periphery FOV 706 of an image frame 798, via two invocations of an NRT core. Subsequent to operation of a fovea sensor, as described herein, image data for the image frame 798 (e.g., a current image frame n) may be provided for spatio-temporal filtering.

For example, image data associated with the periphery FOV 706 for the image frame 798 (e.g., the current image frame n) may be provided to an image front end 708 for inline processing of the current image frame n (e.g., downscaling). The image front end 708 may provide DS4 resolution and DS16 resolution representations of the current image frame n for spatio-temporal filtering 714 (e.g., via a first invocation of an NRT core) and may provide a DS8 resolution representation of the current image frame n for spatio-temporal filtering 716 (e.g., via a second invocation of an NRT core). Image data associated with the fovea FOV 702 for the image frame 798 (e.g., the current image frame n) may be provided to an image front end 710 for inline processing of the current image frame n (e.g., downscaling). The image front end 710 may provide a 1:1/full resolution representation of the current image frame n for the spatio-temporal filtering 714 (e.g., via the first invocation of an NRT core). Image data associated with the mid-fovea FOV 704 for the image frame 798 (e.g., the current image frame n) may be provided to an image front end 712 for inline processing of the current image frame n (e.g., downscaling). The image front end 712 may provide a DS2 resolution representation of the current image frame n for the spatio-temporal filtering 716 (e.g., via the second invocation of an NRT core).

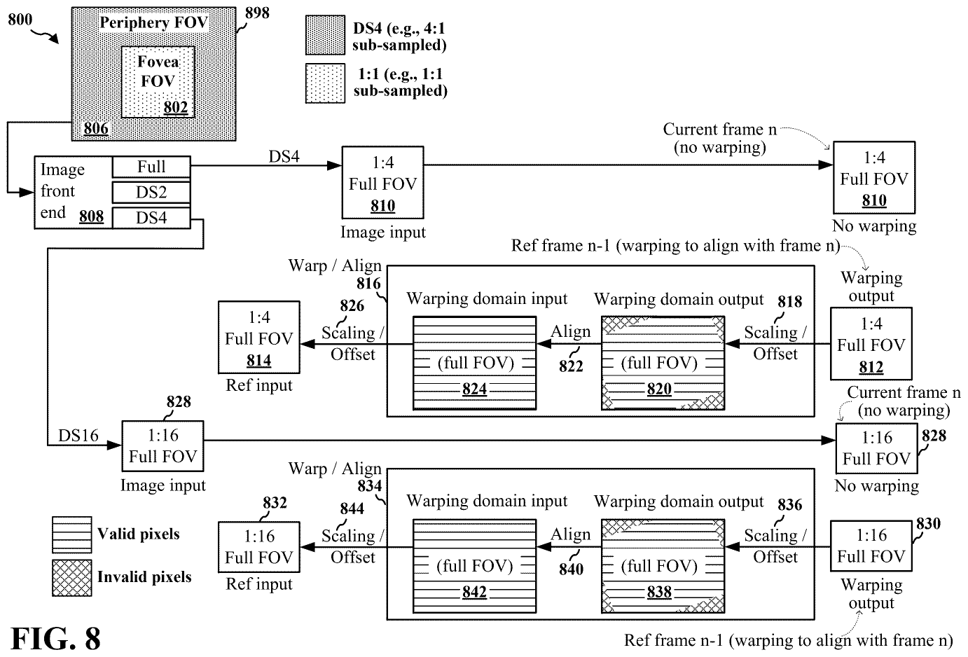

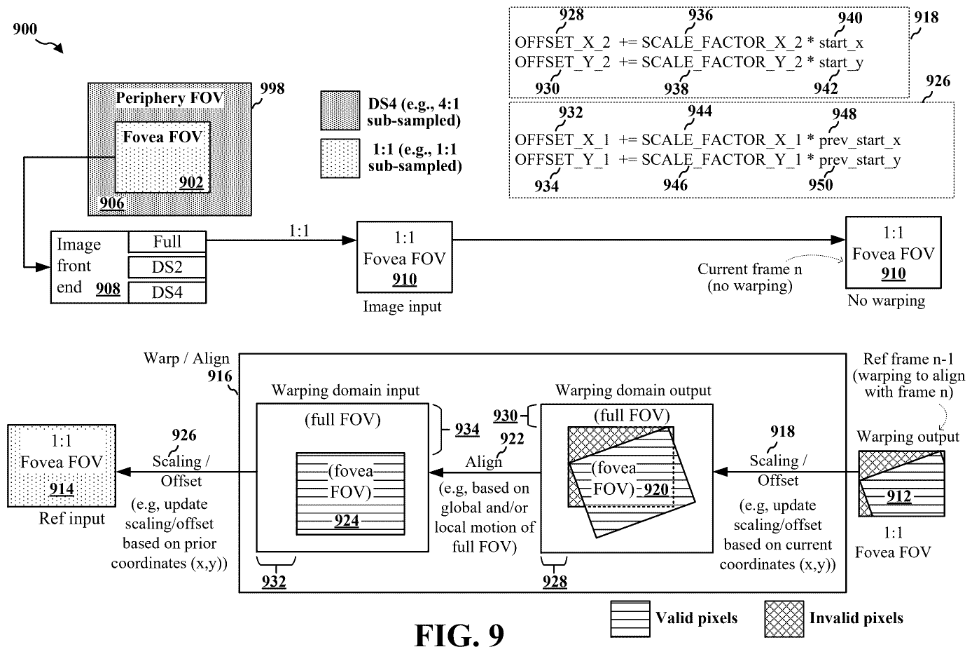

The spatio-temporal filtering 714 may be multi-pass for image quality improvement, as shown by way of example for 3-pass filtering (e.g., based on the 1:1, DS4, and DS16 resolutions, although additional passes are enabled by aspects). The spatio-temporal filtering 714 may blend frame n, for the image frame 798, with a prior image frame n-1 to reduce noise in the filtering. For each pass, the spatio-temporal filtering 714 may use its previous output, shown by the feedback/reference inputs shown. Such reference inputs may pass through an instance of a warp/alignment block 736, as described herein, such as below for FIGS. 8, 9. As one example, instances of the warp/alignment block 736 may receive outputs of the spatio-temporal filtering 714 as reference frames, also prior frames n-1, such as a 1:1 reference frame, a DS4 reference frame, and a DS16 reference frame, for filtering of the current image frame n. The warp/alignment block 736 may be configured to align frame n-1 with frame n for the spatio-temporal filtering 714. A filtered fovea FOV 724 at a 1:1 resolution and a filtered periphery FOV 726 at a DS4 resolution for the current image frame n (e.g., the image frame 798) may be output, e.g., tapped, by the spatio-temporal filtering 714 for post processing 718 and for post processing 720, respectively (e.g., image processing for tone, color, sharpness, and/or the like), after which, the filtered output for the fovea FOV 730 and the filtered output for the periphery FOV 732 may be merged together and/or with other filtered outputs for different FOVs to generate blended image data. In aspects, determining a filtered output for a FOV at a given resolution may include filtering a portion of image data together with one or more other portions of image data via spatio-temporal filtering (e.g., the spatio-temporal filtering 714 may take 1:1/full resolution, DS4 resolution, and DS16 resolution representations of the current image frame n from image front ends as inputs and filter these representations together to determine a filtered output(s) (e.g., the filtered fovea FOV 724, the filtered periphery FOV 726)).

The spatio-temporal filtering 716 may also be multi-pass for image quality improvement, as shown by way of example for 2-pass filtering (e.g., based on the DS2 and DS8 resolutions, although additional passes are enabled by aspects). The spatio-temporal filtering 716 may blend frame n, for the image frame 798, with a prior image frame n-1 to reduce noise in the filtering. For each pass, the spatio-temporal filtering 716 may use its previous output, shown by the feedback/reference inputs shown. Such reference inputs may pass through an instance of a warp/alignment block 736, as described herein, such as below for FIGS. 8, 9. As one example, instances of the warp/alignment block 736 may receive outputs of the spatio-temporal filtering 716 as reference frames, also prior frames n-1, such as a DS2 reference frame and a DS8 reference frame, for filtering of the current image frame n. The warp/alignment block 736 may be configured to align frame n-1 with frame n for the spatio-temporal filtering 716. A filtered mid-fovea FOV 728 at a DS2 resolution for the current image frame n (e.g., the image frame 798) may be output, e.g., tapped, by the spatio-temporal filtering 716 for post processing 722 (e.g., image processing for tone, color, sharpness, and/or the like), after which, the filtered output for the mid-fovea FOV 734 may be merged with other filtered outputs for different FOVs (e.g., the filtered output for the fovea FOV 730 and/or the filtered output for the periphery FOV 732) to generate blended image data.

Accordingly, aspects for joint processing of foveated streams provide reduced numbers of invocations for spatio-temporal filtering blocks, e.g., NRT cores, by joint processing of the fovea and periphery streams that leverage commonalities in foveated stream processing. Corresponding warping techniques allow for maintaining the full FOV transformations instead of maintaining transformations for each stream. As one example, aspects enable multi-level passes for spatio-temporal filtering to be scheduled such that DS4 and DS16 passes for fovea FOVs may be taken from periphery FOV streams of the foveation sensor, and a second-pass output of the periphery FOV for spatio-temporal filtering may be tapped off for post processing to reduce invocations of NRT cores.

In aspects, due to rapid eye-gaze changes by a user/viewer, there may be a high number of invalid pixels in the output of the warping/alignment block 736. For example, when an object 740 is focused on in a prior frame n-1 for a fovea FOV by a user/viewer and the eye-gaze rapidly changes between frames to a current frame n for a fovea FOV at a different location, high number of pixels from the prior frame n-1 may be invalid. Additionally, gyro-and global-motion based examples for alignment do not sufficiently predict alignments due to eye-gaze changes when an object 742 focused on for a fovea FOV in a prior frame n-1 moves between frames to a current frame n as such examples to not account for both current and prior coordinates of the fovea FOV for the current frame n and the prior frame n-1.

Aspects herein for joint processing of foveated streams, e.g., as described below, optimize spatio-temporal filtering to reduce/eliminate the issues noted above.

FIG. 8 illustrates a diagram 800 for warping and alignment for joint processing of foveated streams in accordance with one or more techniques of this disclosure. Diagram 800 may be an aspect of diagram 700 in FIG. 7 and shows warping and alignment aspects for full FOV streams (e.g., at DS4 and DS16 resolutions). Diagram 800 is described, by way of example, in the context of a fovea FOV 802 and a periphery FOV 806 of an image frame 898 (e.g., two foveated streams, while aspects are extensible for full FOV streams in 3-pass configurations).

Subsequent to operation of a fovea sensor, the periphery FOV 806 (e.g., image data for the image frame 898, a current image frame n) may be provided to an image front end 808 for inline processing of the current image frame n (e.g., downscaling). The image front end 808 may provide DS4 resolution and DS16 resolution representations of the current image frame n for spatio-temporal filtering. The spatio-temporal filtering may be multi-pass for image quality improvement. The scales of the spatio-temporal filtering for multi-pass may be any ratio, and are shown by way of example as 1:1, DS4, and DS16 scales, but may also applies to other examples, such as but without limitation, 1:1, DS2, and DS4, etc.). The spatio-temporal filtering may blend frame n with frame n-1 to reduce noise in the filtering.

As described herein, a reference image or a previous output image (e.g., frame n-1) may be received and warped by a warp/alignment block to align the reference to the current frame (e.g., frame n) for performing the spatio-temporal filtering. A periphery FOV image frame representation 810, at DS4 resolution and full FOV, of the current image frame n may be provided from the image front end 808 as an input image frame for spatio-temporal filtering that is not warped by a warp/alignment block 816. With reference to a full FOV DS4 representation 812, by way of example, the warp/alignment block 816 performs warping and alignment. For each output pixel of the full FOV DS4 representation 812, a coordinate in the warping domain output for the full FOV DS4 representation 812 may be calculated by a scaling and offset 818 as appropriate to generate a reference representation 820. A main alignment 822 (e.g., global and/or local) may be performed on the reference representation 820 in a warping domain (e.g., input/output warping domains) to generate an aligned reference representation 824, and the coordinates in the input image may be calculated from the warping input domain by a second set of scaling and offsets 826 configuration for the aligned reference representation 824 to generate the reference input 814 for the prior frame n-1 at the DS4 resolution and for the full FOV.

A periphery FOV image frame representation 828, at DS16 resolution and full FOV, of the current image frame n may be provided from the image front end 808 as an input image frame for spatio-temporal filtering that is not warped by a warp/alignment block 834. With reference to a full FOV DS16 representation 830, by way of example, the warp/alignment block 834 performs warping and alignment. For each output pixel of the full FOV DS16 representation 830, a coordinate in the warping domain output for the full FOV DS16 representation 830 may be calculated by a scaling and offset 836 as appropriate to generate a reference representation 838. A main alignment 840 (e.g., global and/or local) may be performed on the reference representation 838 in a warping domain (e.g., input/output warping domains) to generate an aligned reference representation 842, and the coordinates in the input image may be calculated from the warping input domain by a second set of scaling and offsets 844 configuration for the aligned reference representation 842 to generate the reference input 832 for the prior frame n-1 at the DS16 resolution and for the full FOV.

FIG. 9 illustrates a diagram 900 for warping and alignment for joint processing of foveated streams in accordance with one or more techniques of this disclosure. Diagram 900 may be an aspect of diagram 700 in FIG. 7 and/or diagram 800 in FIG. 8, and shows warping and alignment aspects for fovea FOV streams (e.g., at 1:1 (full) and DS2 resolutions). Diagram 900 is described, by way of example, in the context of a fovea FOV 902 and a periphery FOV 906 of an image frame 998 (e.g., two foveated streams, while aspects are extensible for full FOV streams in 3-pass configurations).

Subsequent to operation of a fovea sensor, the fovea FOV 902 (e.g., image data for the image frame 998, a current image frame n) may be provided to an image front end 908 for inline processing of the current image frame n (e.g., downscaling). The image front end 908 may provide a 1:1 (full) resolution representation of the current image frame n associated with the fovea FOV 902 for spatio-temporal filtering. The spatio-temporal filtering may be multi-pass for image quality improvement. The scales of the spatio-temporal filtering for multi-pass may be any ratio, e.g., 1:1, DS2, DS4, DS8, DS16 scales, and/or the like, but may also applies to other examples). The spatio-temporal filtering may blend frame n with frame n-1 to reduce noise in the filtering.

As described herein, a reference image or a previous output image (e.g., frame n-1) may be received and warped by a warp/alignment block to align the reference to the current frame (e.g., frame n) for performing the spatio-temporal filtering. A fovea FOV image frame representation 910, at 1:1 (full) resolution and the fovea FOV 802, of the current image frame n may be provided from the image front end 908 as an input image frame for spatio-temporal filtering that is not warped by a warp/alignment block 916. With reference to a fovea FOV 1:1 representation 912, by way of example, the warp/alignment block 916 performs warping and alignment. For each output pixel of the fovea FOV 1:1 representation 912, a coordinate in the warping domain output for the fovea FOV 1:1 representation 912 may be calculated by a scaling and offset 918 as appropriate to generate a reference representation 920. A main alignment 922 (e.g., global and/or local) may be performed on the reference representation 920 in a warping domain (e.g., input/output warping domains) to generate an aligned reference representation 924, and the coordinates in the input image may be calculated from the warping input domain by a second set of scaling and offsets 926 configuration for the aligned reference representation 924 to generate the reference input 914 for the prior frame n-1 at the 1:1 (full) resolution and for the fovea FOV 802.

Additionally, as shown in FIG. 9 and noted herein, the fovea FOV 1:1 representation 912 may undergo the scaling and offset 918 as appropriate by the warp/alignment block 916 to generate to reference representation 920 based on current frame n and prior frame n-1 coordinates. As one example, the warp/alignment block 916 may align the reference fovea FOV output (e.g., the fovea FOV 1:1 representation 912) to the relevant section warping output domain (e.g., the reference representation 920) using fovea coordinates as the offsets (e.g., with scaling) as shown by an offset_x_2 928 and an offset_y_2 930 (e.g., current frame n coordinates (x,y)). The offset_x_2 928 may be based on a scale factor 936 and a current x-coordinate 940 of the fovea of the current frame n′, and the offset_y_2 930 may be based on a scale factor 938 and a current y-coordinate 942 of the fovea of the current frame n. Accordingly, the reference fovea frame may be aligned with the input fovea frame. The warp/alignment block 916 may be configured to apply the same warping in the warping domain as for the full FOV streams described above for FIG. 8.

The warp/alignment block 916 may also align the reference fovea FOV input (e.g., the aligned reference representation 924) to the relevant section warping input domain using previous fovea coordinates as the offsets (e.g., with scaling) as shown by an offset_x_1 932 and an offset_y_1 934 (e.g., previous/prior frame n-1 coordinates (x,y)). The offset_x_1 932 may be based on a scale factor 944 and a prior x-coordinate 948 of the fovea for the reference frame (frame n-1), and the offset_y_1 934 may be based on a scale factor 946 and a prior y-coordinate 950 of the fovea for the reference frame (frame n-1). Accordingly, the reference fovea frame may be aligned as per the reference frame full FOV, allowing application the full FOV transformation in the virtual domain as described above for FIG. 8. In aspects, the scaling may also be used in cases where the downscaling ratios in the foveated sensor are not the same as those to be utilized for the multi-pass spatio-temporal filtering.

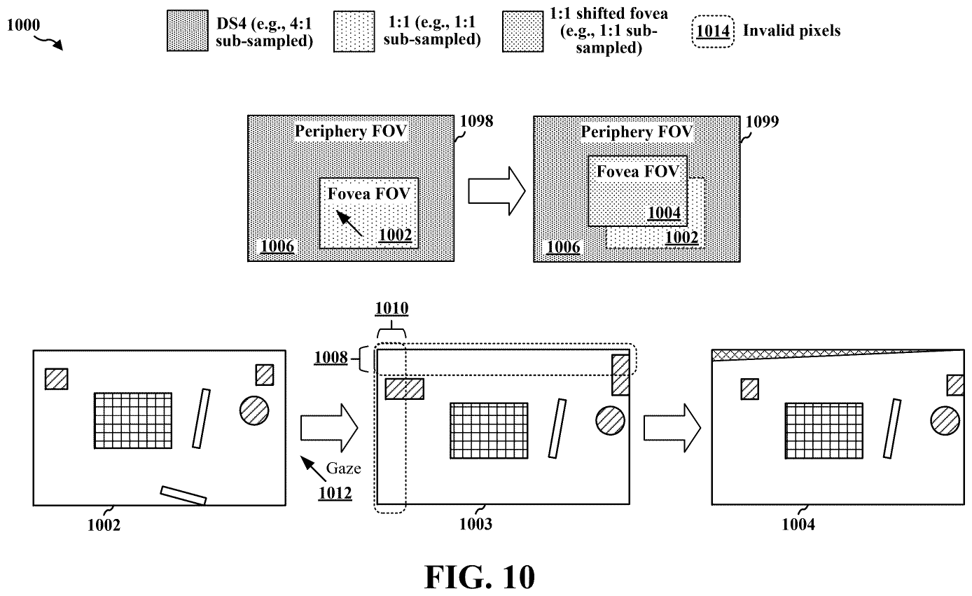

FIG. 10 illustrates a diagram 1000 for warping and alignment for joint processing of foveated streams in accordance with one or more techniques of this disclosure. Diagram 1000 may be an aspect of diagram 900 in FIG. 9, and shows warping and alignment aspects for fovea FOV streams (e.g., at 1:1 (full) and DS2 resolutions) in the context of offsets, as described for FIG. 9, and elimination/reduction of invalid pixels. Diagram 1000 is further described, by way of example, in the context of a fovea FOV 1002 and a periphery FOV 1006 of an image frame 1098 (e.g., a previous/prior image frame n-1) (e.g., two foveated streams, while aspects are extensible for full FOV streams in 3-pass configurations), where an eye-gaze change alters the ROI for fovea FOV 1002 to a fovea FOV 1004 (e.g., a shifted fovea FOV) in an image frame 1099 (e.g., a current image frame n).

In aspects, an eye-gaze change 1012 (e.g., shown as an eye-gaze rapidly moving up and to the left between a prior image frame n-1 with the fovea FOV 1002 and a current image frame n with the fovea FOV 1004 in diagram 1000) may cause objects in a region of focus for an image frame to be shifted by a distance 1008 in the y-axis and by a distance 1010 in the x-axis (e.g., correspondingly down and to the right). Thus, the image frame 1099 includes an indication of the fovea FOV 1002 as representative of a full FOV frame in the warping domain. A fovea FOV 1003 is shown to illustrate a foveated reference input (e.g., for a prior frame n-1) before warping and alignment, as described above for FIG. 9. The fovea FOV 1003 includes invalid pixels 1014 in regions representative of invalid pixels based on warping and alignment. With utilization of the offsets described above (e.g., the offset_x_2 928, the offset_y_2 930, the offset_x_1 932, and the offset_y_1 934 in FIG. 9), however, the full FOV transformation (e.g., as used for as DS4 and DS16 resolution streams) in the warping domain may be utilized to align the reference and input fovea frames, with some of the invalid pixels 1014. In some aspects, fovea margins (e.g., margin regions) may be used to reduce/eliminate the the invalid pixels 1014 to achieve an improvement for the fovea 1004 (e.g., a shifted fovea FOV), as described in further detail below.

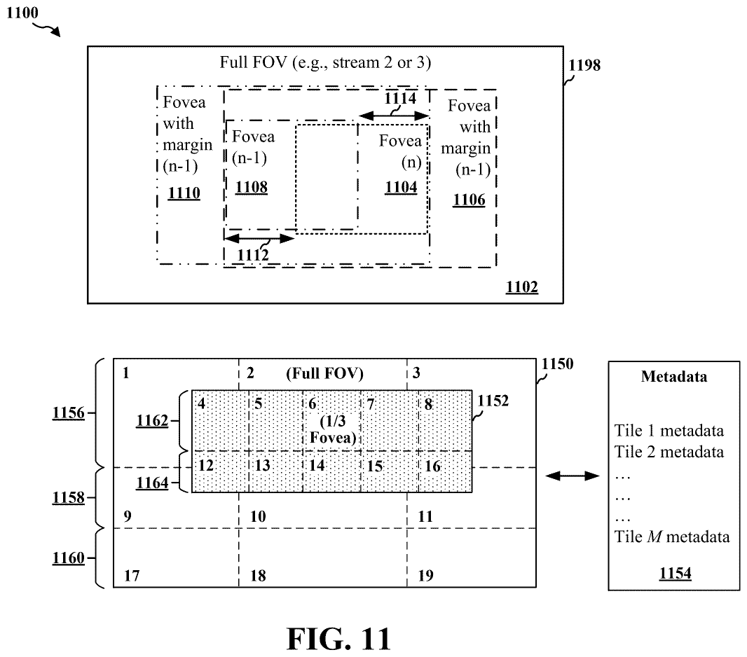

FIG. 11 illustrates a diagram 1100 for fovea margins and tile-based joint processing of foveated streams in accordance with one or more techniques of this disclosure. Diagram 1100 may be an aspect of diagram 700 in FIG. 7, diagram 900 in FIG. 9, and/or of diagram 1000 in FIG. 10, and shows fovea margin and tile-based joint processing of foveated streams aspects for fovea FOV streams (e.g., at 1:1 (full) and DS2 resolutions) in the context of fovea margins (e.g., margin regions) for elimination/reduction of invalid pixels and tile-based joint processing for information utilization.

Diagram 1100 illustrates a fovea FOV 1104 for a current image frame (e.g., an image frame 1198 with a full periphery FOV 1102) and a fovea FOV 1108 for a prior image frame n-1. The fovea FOV 1104 for the current image frame represents a shift to the right with reference to the fovea FOV 1108 for the prior image frame n-1 based on a quick change in eye-gaze between the frames. Aspects herein provide for utilization of fovea margins to eliminate/reduce a number of invalid pixels, as noted above, during spatio-temporal filtering. As shown, the fovea FOV 1104 may include a fovea margin 1112 to increase the fovea FOV 1104 to the size of a fovea FOV with margin 1106. Likewise, the fovea FOV 1108 may include a fovea margin 1114 to increase the fovea FOV 1108 to the size of a fovea FOV with margin 1110. In aspects, the fovea margin 1112 and the fovea margin 1114 may be added to the fovea FOV 1104 and the fovea FOV 1108, respectively, prior to spatio-temporal filtering, and then cropped out or removed after the associated reference frame is generated.

As one example, saccadic movements such as quick eye movements, may change the eye-gaze to different locations in the image frame 1198, such as between the fovea FOV 1104 and the fovea FOV 1108. In this example, a full FOV may be approximately 100°, and saccadic movements may alter the eye-gaze at approximately 700° per second (e.g., approximately 8° in 11 ms between two frames with the fovea FOV 1104 and the fovea FOV 1108 for a 90 Hz display panel refresh rate; this may account for approximately 8% of the full periphery FOV 1102 for the image frame 1198. Addition of the fovea margin 1112 and the fovea margin 1114 may reduce or eliminate a number of invalid pixels during spatio-temporal filtering due to eye-gaze changes. In this example, margins may be determined by a display processor considering 8+8% of the full periphery FOV 1102, or put another way, 320+320 pixels for a 4k×4k display panel. Aspects may also provide for configurations that account for considerations in tradeoffs between noise at the fovea boundary against higher margin values. In aspects, a first size of the fovea margin 1112 and/or a second size of the fovea margin 1114 (e.g., a number of pixels) may be based on a full resolution of image data, a maximum rate of gaze shift per frame of image data, a number of invalid pixels associated with blending a FOV(s), etc.

Diagram 1100 in FIG. 11 also shows a tiling example in the context of a full periphery FOV 1150 and a fovea FOV 1152. As shown, the full periphery FOV 1150 and the fovea FOV 1152 are each divided/segmented into sets of tiles. The optimized flow based on tiling for joint processing of foveated streams creates a dependency between the fovea FOV 1152 region, and metadata 1154 that is utilized in the higher passes of spatio-temporal filtering may be obtained from the lower passes, according to aspects. In this example, the metadata 1154 for the full pass ⅓^{rd} fovea region (e.g., the fovea FOV 1152) may be based on/may come from the DS4 resolution information for the full periphery FOV 1150.

Because a fovea location may change “per-frame” based on the eye-gaze, the tile-division may also change on a per-frame basis, in aspects. A display processor may be configured to execute/implement an algorithm to divide the fovea FOV 1152 into tiles and account for minimum dimensional constraints imposed by hardware, such as by extending the input configuration. Based on the fovea location, the number of tiles in the y-direction may also be different for each fovea FOV, and aspects include a scheduling algorithm to determine the order of NRT core invocation that satisfies the metadata information dependency relationship.

For instance, the full periphery FOV 1150 may be assigned/divided into a row/set of tiles 1156, a row/set of tiles 1158, and a row/set of tiles 1160, by way of example. The fovea FOV 1152 may be assigned/divided into a row/set of tiles 1162 and a row/set of tiles 1164, by way of example. Each tile may be associated with a unique ordered identifier, and the unique ordered identifiers for tiles the full periphery FOV 1150 and the fovea FOV 1152, when combined, may form a set of sequential ordered identifiers. As one example, the row/set of tiles 1156 may include three tiles respectively associated with the unique ordered identifiers {1, 2, 3}, the row/set of tiles 1158 may include three tiles respectively associated with the unique ordered identifiers {9, 10, 11}, and the row/set of tiles 1160 may include three tiles respectively associated with the unique ordered identifiers {17, 18, 19}. The row/set of tiles 1162 may include five tiles respectively associated with the unique ordered identifiers {4, 5, 6, 7, 8}, and a row/set of tiles 1164 may include five tiles respectively associated with the unique ordered identifiers {12, 13, 14, 15, 16}. Thus combined, a set of sequential ordered identifiers is formed for ordering of processing dependency, e.g., for calls to a NRT core(s): {1, 2, 3, 4, 5, 6, 7, 8, 9, 10, 11, 12, 13, 14, 15, 16, 17, 18, 19}. Aspects also provide for different numbers of tiles in any given row/set of tiles.

According aspects, the scheduling algorithm first performs spatio-temporal filtering, e.g., via NRT core invocation, for the the row/set of tiles 1156 that includes three tiles respectively associated with the unique ordered identifiers {1, 2, 3}. Accordingly, the metadata for tiles with the unique ordered identifiers {1, 2, 3} may be obtained. Because the row/set of tiles 1156 occupies the region in which the row/set of tiles 1162 resides, the metadata for tiles with the unique ordered identifiers {1, 2, 3} may be utilized for next performing spatio-temporal filtering for the row/set of tiles 1162 that includes five tiles respectively associated with the unique ordered identifiers {4, 5, 6, 7, 8}, which may not be processed for spatio-temporal filtering prior to acquisition of tile metadata in the metadata 1154 for the row/set of tiles 1156. After this next performance of spatio-temporal filtering for the row/set of tiles 1162, no other rows/sets of tiles for the fovea FOV 1152 have corresponding, processed/filtered rows/sets of tiles for the full periphery FOV 1150—thus, the algorithm may return to processing the next row/set of tiles for the full periphery FOV 1150 (e.g., the row/set of tiles 1158 that include three tiles respectively associated with the unique ordered identifiers {9, 10, 11}), while tiles 1 to 8 may be provided downstream for further processing (e.g., by a graphics processor), instead of waiting for the entire frame, to reduce latency. Subsequently, the row/set of tiles 1164 that includes five tiles respectively associated with the unique ordered identifiers {12, 13, 14, 15, 16} may be processed for spatio-temporal filtering based on tile metadata of the metadata 1154 for the row/set of tiles 1158, and then the row/set of tiles 1160 may be processed for spatio-temporal filtering, while tiles 9 to 16 may be provided downstream for further processing in such a two-dimensional tiling approach for latency reduction (e.g., as NRT processing may be utilized without entire frames).

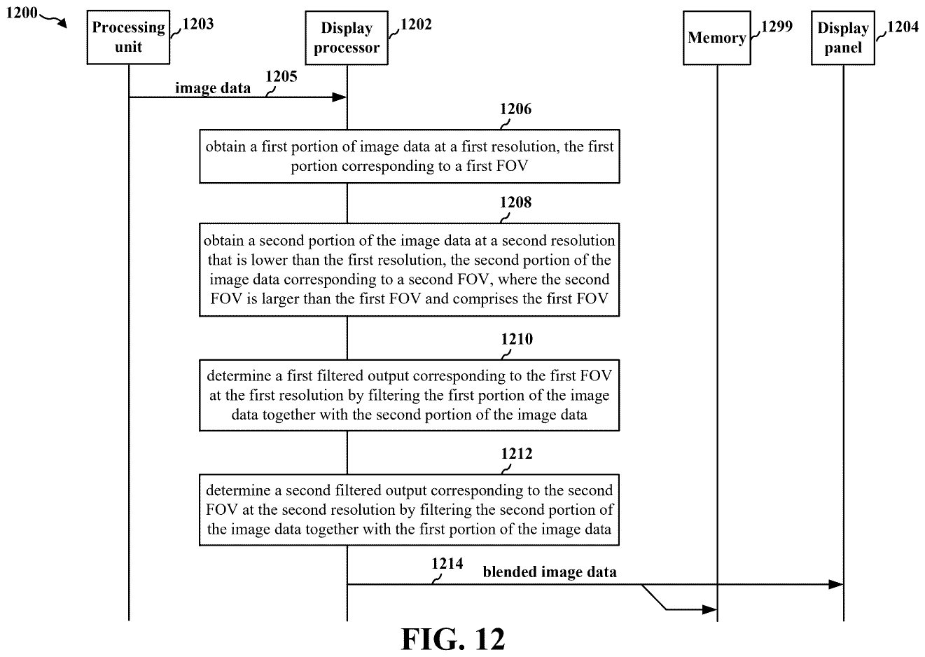

FIG. 12 is a call flow diagram 1200 for illustrating example communications between a display processor 1202 and a display panel 1204 in accordance with one or more techniques of this disclosure. In aspects, call flow diagram 1200 is described for joint processing of foveated streams, e.g., in NRT cores. In an example, the display processor 1202 may be or include the display processor 127/the fovea stream joint processor 198. In aspects, as shown, a processing unit 1203, e.g., the processing unit 120, may also communicate with the display processor 1202. In aspects, the display processor 1202 comprises a wireless communication device that is configured to perform the call flow diagram 1200.

The display processor 1202 may be configured to obtain (at 1206) a first portion of image data 1205 at a first resolution, the first portion corresponding to a first FOV. In some aspects, the image data 1205 may be obtained by the display processor 1202 via the processing unit 1203, e.g., from an application such as an XR application, and/or the like. The first portion of the image data 1205 may be obtained by the display processor 1202 via a sensor, e.g., a fovea sensor, and/or via an indication received in association with the image data 1205; in aspects, the first portion of the image data 1205 may be obtained also via an image front end configured for inline image data processing and/or sampling/down sampling for full/lower image data resolutions associated with the image data 1205. The first FOV may be a fovea FOV and a second FOV may be a periphery FOV.

The display processor 1202 may be configured to obtain (at 1208) a second portion of the image data 1205 at a second resolution that is lower than the first resolution, the second portion of the image data 1205 corresponding to a second FOV, where the second FOV is larger than the first FOV and comprises the first FOV. The second portion of the image data 1205 may be obtained by the display processor 1202 via a sensor, e.g., a fovea sensor, and/or via an indication received in association with the image data 1205; in aspects, the second portion of the image data 1205 may be obtained also via an image front end configured for inline image data processing and/or sampling/down sampling for full/lower image data resolutions associated with the image data 1205. The first FOV may be a fovea FOV and the second FOV may be a periphery FOV.

The display processor 1202 may also be configured to obtain a third portion of the image data 1205 at a third resolution that is lower than the first resolution and the second resolution, the third portion of the image data 1205 corresponding to the second FOV. The third portion of the image data 1205 may be obtained by the display processor 1202 via an image front end configured for inline image data processing and/or sampling/down sampling for full/lower image data resolutions associated with the image data 1205. The display processor 1202 may also be configured to obtain a fourth portion of the image data 1205 at a third resolution that is lower than the first resolution and higher than the second resolution. The fourth portion of the image data 1205 may correspond to a third FOV, where the third FOV is larger than the first FOV and comprises the first FOV and where the second FOV is larger than the third FOV and comprises the third FOV. The fourth portion of the image data 1205 may be obtained by the display processor 1202 via a sensor, e.g., a fovea sensor, and/or via an indication received in association with the image data 1205; in aspects, the fourth portion of the image data 1205 may be obtained also via an image front end configured for inline image data processing and/or sampling/down sampling for full/lower image data resolutions associated with the image data 1205. The display processor 1202 may also be configured to obtain a fifth portion of the image data 1205 at a fourth resolution that is lower than the second resolution, the fifth portion of the image data 1205 corresponding to the second FOV. The fifth portion of the image data 1205 may be obtained by the display processor 1202 via an image front end configured for inline image data processing and/or sampling/down sampling for full/lower image data resolutions associated with the image data 1205.

The display processor 1202 may be configured to determine (at 1210) a first filtered output corresponding to the first FOV at the first resolution by filtering the first portion of the image data 1205 together with the second portion of the image data 1205. In aspects, to determine the first filtered output corresponding to the first FOV at the first resolution, the display processor 1202 may be configured to filter the first portion of the image data 1205, the second portion of the image data 1205, and the third portion of the image data 1205 together. In aspects, to determine the first filtered output, the display processor 1202 may be configured to determine the first filtered output via a call to a NRT core.

The display processor 1202 may be configured to determine (at 1212) a second filtered output corresponding to the second FOV at the second resolution by filtering the second portion of the image data 1205 together with the first portion of the image data 1205. In aspects, to determine the second filtered output corresponding to the second FOV at the second resolution, the display processor 1202 may be configured to filter the second portion of the image data 1205, the third portion of the image data 1205, and the first portion of the image data 1205 together. In aspects, to determine the second filtered output, the display processor 1202 may be configured to determine the second filtered output via the call to the NRT core concurrently (which may include aspects for at least partially concurrently) with the first filtered output. In aspects, to filter the first portion of the image data 1205 and the second portion of the image data 1205 together, the display processor 1202 may be configured to filter based on spatio-temporal filtering, and the display processor 1202 may be configured to blend the first FOV and the second FOV with a prior first FOV and a prior second FOV, respectively, based on at least one of an alignment or a warp associated with a prior frame of the image data 1205 with reference to a current frame of the image data 1205.

In aspects, the first portion of the image data 1205 and the first FOV may correspond to a fovea portion of the image data 1205 and the second portion of the image data 1205 and the second FOV may correspond to a periphery portion of the image data 1205. In such aspects, the display processor 1202, to blend the first FOV, may be configured to align a prior first FOV corresponding to a prior frame of the image data 1205 with a full FOV reference frame of the image data 1205 for the alignment based on a first set of offsets associated with first fovea coordinates for the first FOV and a first scaling factor, to warp the aligned prior first FOV based on the full FOV reference frame, and to align the warped, aligned prior first FOV with the full FOV reference frame based on a second set of offsets associated with second fovea coordinates for the second FOV and a second scaling factor.

In some aspects, the first FOV includes a first margin region that surrounds the fovea portion and the prior first FOV includes a prior margin region that surrounds a prior fovea portion. In such aspects, to blend the first FOV, the display processor 1202 may be configured to add, before the alignment of the prior first FOV, at least one of the first margin region to the first FOV or the prior margin region to the prior first FOV, and to remove, subsequent to the alignment of the warped, aligned prior first FOV, at least one of the first margin region from the first FOV or the prior margin region from the prior first FOV. The first margin region and/or the prior margin region may be based on at least one of a full resolution of the image data 1205, a maximum rate of gaze shift per frame of the image data 1205, a number of invalid pixels associated with blending the first FOV, and/or the like.

In aspects for which the first FOV is a fovea FOV and the second FOV is a periphery FOV, to determine the second filtered output, the display processor 1202 may be configured to divide the second FOV into a second number of tiles, where each of the second number of tiles is associated with a second unique ordered identifier of a set of second identifiers, and to determine the first filtered output, the display processor 1202 may be configured to divide the first FOV into a first number of tiles, where each of the first number of tiles is associated with a first unique ordered identifier of a set of first identifiers. In such aspects, a combination of the set of first identifiers and the set of second identifiers includes or may be a set of sequential ordered identifiers. To filter the second portion of the image data 1205 together with the first portion of the image data 1205, the display processor 1202 may be configured to filter the second portion of the image data 1205 per tile of the second number of tiles based on the second unique ordered identifier associated with each tile until at least one second row of the second number of tiles are filtered tiles that surround at least one first row of the first number of tiles that are unfiltered, and to filter the first portion of the image data 1205 together with the second portion of the image data 1205, the display processor 1202 may be configured to filter, based on second resolution metadata associated with the at least one second row of the second number of tiles that are filtered tiles, the first portion of the image data 1205 per tile of the first number of tiles for the at least one first row based on the first unique ordered identifier associated with each tile in the at least one first row. In such aspects, to filter the second portion of the image data 1205 together with the first portion of the image data 1205, the display processor 1202 may be configured to filter the second portion of the image data 1205 per tile of the second number of tiles based on the second unique ordered identifier associated with each tile until the at least one second row and at least one additional second row of the second number of tiles are the filtered tiles that surround at least one additional first row of the first number of tiles that are unfiltered, and to filter the first portion of the image data 1205 together with the second portion of the image data 1205, the display processor 1202 may be configured to filter, based on metadata for the second resolution associated with one or more of the at least one second row and the at least one additional second row of the second number of tiles that are the filtered tiles, the first portion of the image data 1205 per tile of the first number of tiles for the at least one additional first row based on the first unique ordered identifier associated with each tile in the at least one additional first row. In some aspects, to filter the second portion of the image data 1205 together with the first portion of the image data 1205, the display processor 1202 may be configured to filter the second portion of the image data 1205 per tile of the second number of tiles based on the second unique ordered identifier associated with each tile for a remaining set of unfiltered tiles subsequent to filtering all of the first number of tiles.

The display processor 1202 may also be configured to determine a third filtered output corresponding to the third FOV at the third resolution by filtering the fourth portion of the image data 1205 and the fifth portion of the image data 1205 together. In some aspects, to determine the first filtered output and to determine the second filtered output, the display processor 1202 may be configured to determine the first filtered output and determining the second filtered output concurrently/at least partially concurrently via a first call to a NRT core, and to determine the third filtered output, the display processor 1202 may be configured to determine the third filtered output via a second call to a second NRT core that is different from the first call. The first FOV may be a fovea FOV, the second FOV may be a periphery FOV, and the third FOV may be a mid-fovea FOV.

The display processor 1202 may be configured to output blended image data 1214 based on the first filtered output and the second filtered output. In aspects, to output the blended image data 1214, the display processor 1202 may be configured to output the blended image data 1214 based on the first filtered output, the second filtered output, and the third filtered output. In aspects, the blended image data 1214 output by the display processor 1202 may be provided to the display panel 1204 and/or stored in a memory 1299. In some aspects, the display processor 1202 may be configured to output blended image data based on a merger of the outputs, and the merger of the outputs may be performed via a compositor and/or the like.

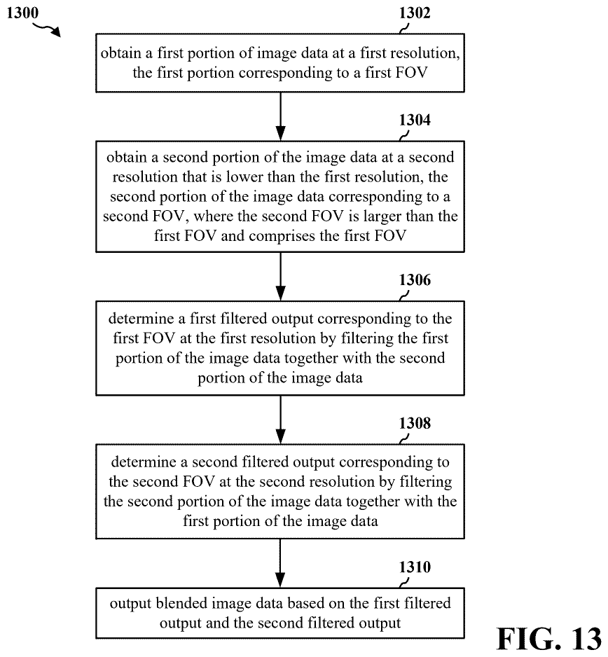

FIG. 13 is a flowchart 1300 of an example method of display processing in accordance with one or more techniques of this disclosure. The method may be for joint processing of foveated streams, e.g., in NRT cores. The method may be performed by an apparatus, such as an apparatus for display processing, a display processing unit (DPU) or other display processor, a wireless communication device, and the like, as used in connection with the aspects of FIGS. 1-12.

At 1302, the apparatus may obtain a first portion of image data at a first resolution, the first portion corresponding to a first FOV. For example, referring to FIG. 12, the display processor 1202 may be configured to obtain (at 1206) a first portion of image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a first resolution, the first portion corresponding to a first FOV. In some aspects, the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via the processing unit 1203, e.g., from an application such as an XR application, and/or the like. The first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The first FOV may be a fovea FOV (e.g., 702 in FIG. 7; 802 in FIG. 8; 902 for 998 in FIG. 9; 1002, 1004 in FIG. 10; 1102, 1152 in FIG. 11) and a second FOV may be a periphery FOV (e.g., 706 in FIG. 7; 806 in FIG. 8; 906 in FIG. 9; 1006 for 1098 in FIG. 10; 1106, 1150 in FIG. 11).

At 1304, the apparatus may obtain a second portion of the image data at a second resolution that is lower than the first resolution, the second portion of the image data corresponding to a second FOV, where the second FOV is larger than the first FOV and comprises the first FOV. For example, referring to FIG. 12, The display processor 1202 may be configured to obtain (at 1208) a second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a second resolution that is lower than the first resolution, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to a second FOV, where the second FOV is larger than the first FOV and comprises the first FOV. The second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The first FOV may be a fovea FOV (e.g., 702 in FIG. 7; 802 in FIG. 8; 902 for 998 in FIG. 9; 1002, 1004 in FIG. 10; 1102, 1152 in FIG. 11) and the second FOV may be a periphery FOV (e.g., 706 in FIG. 7; 806 in FIG. 8; 906 in FIG. 9; 1006 for 1098 in FIG. 10; 1106, 1150 in FIG. 11).

With reference to 1302 and 1304, the display processor 1202 may also be configured to obtain a third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a third resolution that is lower than the first resolution and the second resolution, the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to the second FOV. The third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The display processor 1202 may also be configured to obtain a fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a third resolution (e.g., DS2 in FIGS. 7, 8, 9, 10) that is lower than the first resolution and higher than the second resolution (e.g., DS4 in FIGS. 7, 8, 9, 10), the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to a third FOV, where the third FOV is larger than the first FOV and comprises the first FOV and where the second FOV is larger than the third FOV and comprises the third FOV. The fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The display processor 1202 may also be configured to obtain a fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a fourth resolution that is lower than the second resolution, the fifth portion of the image data 1205 corresponding to the second FOV. The fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

At 1306, the apparatus may determine a first filtered output corresponding to the first FOV at the first resolution by filtering the first portion of the image data together with the second portion of the image data. For example, referring to FIG. 12, the display processor 1202 may be configured to determine (at 1210) a first filtered output (e.g., 730 in FIG. 7) corresponding to the first FOV at the first resolution by filtering (e.g., 714 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). In aspects, to determine the first filtered output (e.g., 730 in FIG. 7) corresponding to the first FOV at the first resolution, the display processor 1202 may be configured to filter the first portion of the image data 1205, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), and the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In aspects, to determine the first filtered output (e.g., 730 in FIG. 7), the display processor 1202 may be configured to determine the first filtered output (e.g., 730 in FIG. 7) via a call to a NRT core (e.g., at 714 in FIG. 7).

At 1308, the apparatus may determine a second filtered output corresponding to the second FOV at the second resolution by filtering the second portion of the image data together with the first portion of the image data. For example, referring to FIG. 12, the display processor 1202 may be configured to determine (at 1212) a second filtered output (e.g., 732 in FIG. 7) corresponding to the second FOV at the second resolution by filtering (e.g., 714 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). In aspects, to determine the second filtered output (e.g., 732 in FIG. 7) corresponding to the second FOV at the second resolution, the display processor 1202 may be configured to filter (e.g., 714 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), and the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In aspects, to determine the second filtered output (e.g., 732 in FIG. 7), the display processor 1202 may be configured to determine the second filtered output (e.g., 732 in FIG. 7) via the call to the NRT core (e.g., at 714 in FIG. 7) concurrently/at least partially concurrently with the first filtered output (e.g., 730 in FIG. 7). In aspects, to filter (e.g., 714 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together, the display processor 1202 may be configured to filter (e.g., 714, 716 in FIG. 7) based on spatio-temporal filtering, and the display processor 1202 may be configured to blend the first FOV and the second FOV with a prior first FOV and a prior second FOV (e.g., frame n-1 in FIG. 7), respectively, based on at least one of an alignment or a warp (e.g., 736 in FIG. 7; 816, 834 in FIG. 8; 916 in FIG. 9) associated with a prior frame (e.g., ref frame n-1 in FIGS. 8, 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) with reference to a current frame (e.g., 810, 828 in FIG. 8; 910 in FIG. 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

With reference to 1306 and 1308, in aspects, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the first FOV may correspond to a fovea portion of the image data 1205 (e.g., 702 for 798 in FIG. 7; 802 for 898 in FIG. 8; 902 for 998 in FIG. 9; 1002, 1004 for 1098 in FIG. 10; 1102, 1104 for 1198, 1152 in FIG. 11) and the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the second FOV may correspond to a periphery portion of the image data 1205 (e.g., 706 for 798 in FIG. 7; 806 for 898 in FIG. 8; 906 for 998 in FIG. 9; 1006 for 1098 in FIG. 10; 1102 for 1198, 1150 in FIG. 11). In such aspects, the display processor 1202, to blend the first FOV, may be configured to align (e.g., 822, 840 in FIG. 8; 922 in FIG. 9) a prior first FOV corresponding to a prior frame (e.g., frame n-1 in FIG. 7) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) with a full FOV reference frame (e.g., 814, 832 in FIG. 8; 914 in FIG. 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) for the alignment (e.g., 822, 840 in FIG. 8; 922 in FIG. 9) based on a first set of offsets (e.g., [928, 930] in FIG. 9) associated with first fovea coordinates for the first FOV and a first scaling factor (e.g., 818, 836 in FIG. 8; 918 in FIG. 9), to warp (e.g., 736 in FIG. 7; 816, 834 in FIG. 8; 916 in FIG. 9) the aligned prior first FOV based on the full FOV reference frame (e.g., 814, 832 in FIG. 8; 914 in FIG. 9), and to align (e.g., 822, 840 in FIG. 8; 922 in FIG. 9) the warped, aligned prior first FOV (e.g., 824, 842 in FIG. 8; 924 in FIG. 9) with the full FOV reference frame (e.g., 814, 832 in FIG. 8; 914 in FIG. 9) based on a second set of offsets (e.g., [932, 934] in FIG. 9) associated with second fovea coordinates for the second FOV and a second scaling factor (e.g., 826, 844 in FIG. 8; 926 in FIG. 9).

In some aspects, the first FOV includes a first margin region (e.g., 1112 in FIG. 11) that surrounds the fovea portion and the prior first FOV includes a prior margin region (e.g., 1114 in FIG. 11) that surrounds a prior fovea portion. In such aspects, to blend the first FOV, the display processor 1202 may be configured to add, before the alignment (e.g., 822, 840 in FIG. 8; 922 in FIG. 9) of the prior first FOV, at least one of the first margin region (e.g., 1112 in FIG. 11) to the first FOV or the prior margin region (e.g., 1114 in FIG. 11) to the prior first FOV, and to remove, subsequent to the alignment (e.g., 822, 840 in FIG. 8; 922 in FIG. 9) of the warped, aligned prior first FOV (e.g., 824, 842 in FIG. 8; 924 in FIG. 9), at least one of the first margin region (e.g., 1112 in FIG. 11) from the first FOV or the prior margin region (e.g., 1114 in FIG. 11) from the prior first FOV. The first margin region (e.g., 1112 in FIG. 11) and/or the prior margin region (e.g., 1114 in FIG. 11) may be based on at least one of a full resolution of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), a maximum rate of gaze shift (e.g., 1012 in FIG. 10; 700°/ sec in FIG. 11) per frame of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), a number of invalid pixels (e.g., 1014 in FIG. 10) associated with blending the first FOV, and/or the like.

In aspects for which the first FOV is a fovea FOV (e.g., 702 in FIG. 7; 802 in FIG. 8; 902 for 998 in FIG. 9; 1002, 1004 in FIG. 10; 1102, 1152 in FIG. 11) and the second FOV is a periphery FOV (e.g., 706 in FIG. 7; 806 in FIG. 8; 906 in FIG. 9; 1006 for 1098 in FIG. 10; 1106, 1150 in FIG. 11), to determine the second filtered output (e.g., 732 in FIG. 7), the display processor 1202 may be configured to divide the second FOV (e.g., 1150 in FIG. 11) into a second number of tiles (e.g., 1156, 1158, 1160 in FIG. 11), where each of the second number of tiles (e.g., 1156, 1158, 1160 in FIG. 11) is associated with a second unique ordered identifier (e.g., 1, 2, 3, 9, 10, 11, 17, 18, 19 in FIG. 11) of a set of second identifiers, and to determine the first filtered output (e.g., 730 in FIG. 7), the display processor 1202 may be configured to divide the first FOV (e.g., 1152 in FIG. 11) into a first number of tiles (e.g., 1162, 1164 in FIG. 11), where each of the first number of tiles (e.g., 1162, 1164 in FIG. 11) is associated with a first unique ordered identifier (e.g., 4, 5, 6, 7, 8, 12, 13, 14, 15, 16 in FIG. 11) of a set of first identifiers. In such aspects, a combination of the set of first identifiers and the set of second identifiers includes or may be a set of sequential ordered identifiers. To filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile until at least one second row (e.g., 1156 in FIG. 11) of the second number of tiles (e.g., 1156, 1158, 1160 in FIG. 11) are filtered tiles that surround at least one first row (e.g., 1162 in FIG. 11) of the first number of tiles (e.g., 1162, 1164 in FIG. 11) that are unfiltered, and to filter (e.g., 714, 716 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7), based on second resolution metadata (e.g., 1154 in FIG. 11) associated with the at least one second row (e.g., 1156 in FIG. 11) of the second number of tiles (e.g., 1156, 1158, 1160 in FIG. 11) that are the filtered tiles, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the first number of tiles (e.g., 1162, 1164 in FIG. 11) for the at least one first row (e.g., 1162 in FIG. 11) based on the first unique ordered identifier (e.g., 4, 5, 6, 7, 8, 12, 13, 14, 15, 16 in FIG. 11) associated with each tile in the at least one first row (e.g., 1162 in FIG. 11). In such aspects, to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile until the at least one second row (e.g., 1156 in FIG. 11) and at least one additional second row (e.g., 1158 in FIG. 11) of the second number of tiles (e.g., 1156, 1158, 1160 in FIG. 11) are the as filtered tiles that surround at least one additional first row (e.g., 1164 in FIG. 11) of the first number of tiles (e.g., 1162, 1164 in FIG. 11) that are unfiltered, and to filter (e.g., 714, 716 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7), based on metadata (e.g., 1154 in FIG. 11) for the second resolution associated with one or more of the at least one second row (e.g., 1156 in FIG. 11) and the at least one additional second row (e.g., 1158 in FIG. 11) of the second number of tiles (e.g., 1156, 1158, 1160 in FIG. 11) that are filtered tiles, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the first number of tiles (e.g., 1162, 1164 in FIG. 11) for the at least one additional first row (e.g., 1164 in FIG. 11) based on the first unique ordered identifier (e.g., 4, 5, 6, 7, 8, 12, 13, 14, 15, 16 in FIG. 11) associated with each tile in the at least one additional first row (e.g., 1164 in FIG. 11). In some aspects, to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile for a remaining set of unfiltered tiles (e.g., 1160 in FIG. 11) subsequent to filtering (e.g., 714, 716 in FIG. 7) all of the first number of tiles (e.g., 1162, 1164 in FIG. 11).

The display processor 1202 may also be configured to determine a third filtered output (e.g., 734 in FIG. 7) corresponding to the third FOV at the third resolution by filtering (e.g., 716 in FIG. 7) the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In some aspects, to determine the first filtered output (e.g., 730 in FIG. 7) and to determine the second filtered output (e.g., 732 in FIG. 7), the display processor 1202 may be configured to determine the first filtered output (e.g., 730 in FIG. 7) and determining the second filtered output (e.g., 732 in FIG. 7) concurrently/at least partially concurrently via a first call to a NRT core (e.g., at 714 in FIG. 7), and to determine the third filtered output (e.g., 734 in FIG. 7), the display processor 1202 may be configured to determine the third filtered output (e.g., 734 in FIG. 7) via a second call to a second NRT core (e.g., at 716 in FIG. 7) that is different from the first call (e.g., 714 in FIG. 7). The first FOV may be a fovea FOV (e.g., 702 in FIG. 7; 802 in FIG. 8; 902 for 998 in FIG. 9; 1002, 1004 in FIG. 10; 1102, 1152 in FIG. 11), the second FOV may be a periphery FOV (e.g., 706 in FIG. 7; 806 in FIG. 8; 906 in FIG. 9; 1006 for 1098 in FIG. 10; 1106, 1150 in FIG. 11), and the third FOV may be a mid-fovea FOV (e.g., 704 in FIG. 7).

At 1310, the apparatus may output blended image data based on the first filtered output and the second filtered output. For example, referring to FIG. 12, the display processor 1202 may be configured to output blended image data 1214 based on the first filtered output (e.g., 730 in FIG. 7) and the second filtered output (e.g., 732 in FIG. 7). In aspects, to output the blended image data 1214, the display processor 1202 may be configured to output the blended image data 1214 based on the first filtered output (e.g., 730 in FIG. 7), the second filtered output (e.g., 732 in FIG. 7), and the third filtered output (e.g., 734 in FIG. 7). In aspects, the blended image data 1214 output by the display processor 1202 may be provided to the display panel 1204 and/or stored in a memory 1299. In some aspects, the display processor 1202 may be configured to output blended image data based on a merger of the outputs (e.g., 730, 732, 734 together in FIG. 7), and the merger of the outputs (e.g., 730, 732, 734 together in FIG. 7) may be performed via a compositor and/or the like.

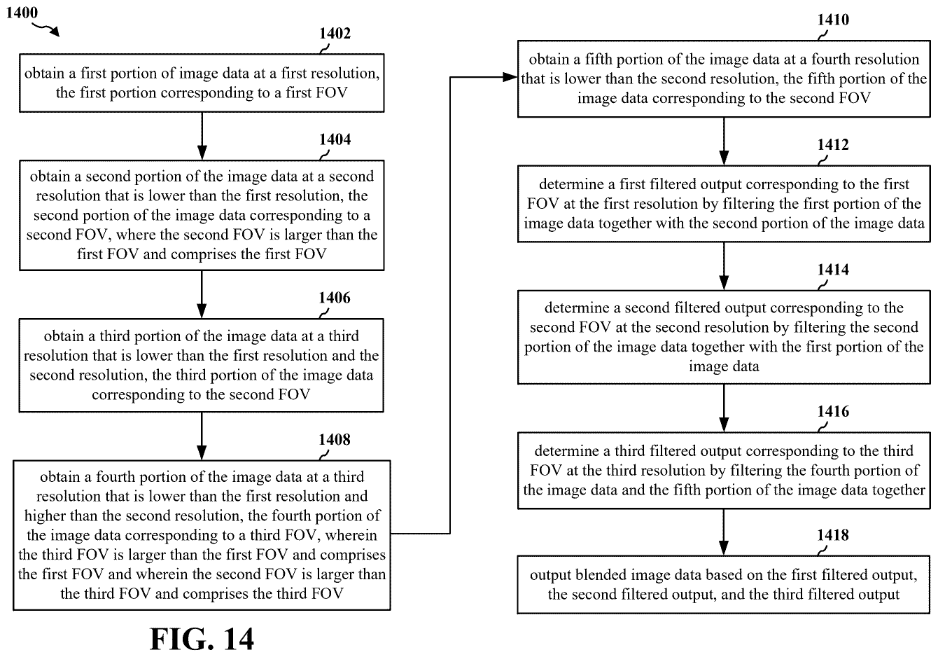

FIG. 14 is a flowchart 1400 of an example method of display processing in accordance with one or more techniques of this disclosure. The method may be for joint processing of foveated streams, e.g., in NRT cores. The method may be performed by an apparatus, such as an apparatus for display processing, a display processing unit (DPU) or other display processor, a wireless communication device, and the like, as used in connection with the aspects of FIGS. 1-12.

At 1402, the apparatus may obtain a first portion of image data at a first resolution, the first portion corresponding to a first FOV. For example, referring to FIG. 12, the display processor 1202 may be configured to obtain (at 1206) a first portion of image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a first resolution, the first portion corresponding to a first FOV. In some aspects, the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via the processing unit 1203, e.g., from an application such as an XR application, and/or the like. The first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The first FOV may be a fovea FOV (e.g., 702 in FIG. 7; 802 in FIG. 8; 902 for 998 in FIG. 9; 1002, 1004 in FIG. 10; 1102, 1152 in FIG. 11) and a second FOV may be a periphery FOV (e.g., 706 in FIG. 7; 806 in FIG. 8; 906 in FIG. 9; 1006 for 1098 in FIG. 10; 1106, 1150 in FIG. 11).

At 1404, the apparatus may obtain a second portion of the image data at a second resolution that is lower than the first resolution, the second portion of the image data corresponding to a second FOV, where the second FOV is larger than the first FOV and comprises the first FOV. For example, referring to FIG. 12, the display processor 1202 may be configured to obtain (at 1208) a second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a second resolution that is lower than the first resolution, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to a second FOV, where the second FOV is larger than the first FOV and comprises the first FOV. The second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). The first FOV may be a fovea FOV (e.g., 702 in FIG. 7; 802 in FIG. 8; 902 for 998 in FIG. 9; 1002, 1004 in FIG. 10; 1102, 1152 in FIG. 11) and the second FOV may be a periphery FOV (e.g., 706 in FIG. 7; 806 in FIG. 8; 906 in FIG. 9; 1006 for 1098 in FIG. 10; 1106, 1150 in FIG. 11).

At 1406, the apparatus may obtain a third portion of the image data at a third resolution that is lower than the first resolution and the second resolution, the third portion of the image data corresponding to the second FOV. For example, referring to FIG. 12, the display processor 1202 may also be configured to obtain a third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a third resolution that is lower than the first resolution and the second resolution, the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to the second FOV. The third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

At 1408, the apparatus may obtain a fourth portion of the image data at a third resolution that is lower than the first resolution and higher than the second resolution, the fourth portion of the image data corresponding to a third FOV, where the third FOV is larger than the first FOV and comprises the first FOV and where the second FOV is larger than the third FOV and comprises the third FOV. For example, referring to FIG. 12, the display processor 1202 may also be configured to obtain a fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a third resolution (e.g., DS2 in FIGS. 7, 8, 9, 10) that is lower than the first resolution and higher than the second resolution (e.g., DS4 in FIGS. 7, 8, 9, 10), the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) corresponding to a third FOV, where the third FOV is larger than the first FOV and comprises the first FOV and where the second FOV is larger than the third FOV and comprises the third FOV. The fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via a sensor, e.g., a fovea sensor (e.g., 502 in FIG. 5), and/or via an indication received in association with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11); in aspects, the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained also via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

At 1410, the apparatus may obtain a fifth portion of the image data at a fourth resolution that is lower than the second resolution, the fifth portion of the image data corresponding to the second FOV. For example, referring to FIG. 12, display processor 1202 may also be configured to obtain a fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) at a fourth resolution that is lower than the second resolution, the fifth portion of the image data 1205 corresponding to the second FOV. The fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) may be obtained by the display processor 1202 via an image front end (e.g., 708, 710, 712 in FIG. 7; 808 in FIG. 8; 908 in FIG. 9) configured for inline image data processing and/or sampling/down sampling for full/lower image data resolutions associated with the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

At 1412, the apparatus may determine a first filtered output corresponding to the first FOV at the first resolution by filtering the first portion of the image data together with the second portion of the image data. For example, referring to FIG. 12, the display processor 1202 may be configured to determine (at 1210) a first filtered output (e.g., 730 in FIG. 7) corresponding to the first FOV at the first resolution by filtering (e.g., 714 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). In aspects, to determine the first filtered output (e.g., 730 in FIG. 7) corresponding to the first FOV at the first resolution, the display processor 1202 may be configured to filter the first portion of the image data 1205, the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), and the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In aspects, to determine the first filtered output (e.g., 730 in FIG. 7), the display processor 1202 may be configured to determine the first filtered output (e.g., 730 in FIG. 7) via a call to a NRT core (e.g., at 714 in FIG. 7).

At 1414, the apparatus may determine a second filtered output corresponding to the second FOV at the second resolution by filtering the second portion of the image data together with the first portion of the image data. For example, referring to FIG. 12, the display processor 1202 may be configured to determine (at 1212) a second filtered output (e.g., 732 in FIG. 7) corresponding to the second FOV at the second resolution by filtering (e.g., 714 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11). In aspects, to determine the second filtered output (e.g., 732 in FIG. 7) corresponding to the second FOV at the second resolution, the display processor 1202 may be configured to filter (e.g., 714 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the third portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), and the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In aspects, to determine the second filtered output (e.g., 732 in FIG. 7), the display processor 1202 may be configured to determine the second filtered output (e.g., 732 in FIG. 7) via the call to the NRT core (e.g., at 714 in FIG. 7) concurrently/at least partially concurrently with the first filtered output (e.g., 730 in FIG. 7). In aspects, to filter (e.g., 714 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together, the display processor 1202 may be configured to filter (e.g., 714, 716 in FIG. 7) based on spatio-temporal filtering, and the display processor 1202 may be configured to blend the first FOV and the second FOV with a prior first FOV and a prior second FOV (e.g., frame n-1 in FIG. 7), respectively, based on at least one of an alignment or a warp (e.g., 736 in FIG. 7; 816, 834 in FIG. 8; 916 in FIG. 9) associated with a prior frame (e.g., ref frame n-1 in FIGS. 8, 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) with reference to a current frame (e.g., 810, 828 in FIG. 8; 910 in FIG. 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11).

With reference to 1306 and 1308, in aspects, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the first FOV may correspond to a fovea portion of the image data 1205 (e.g., 702 for 798 in FIG. 7; 802 for 898 in FIG. 8; 902 for 998 in FIG. 9; 1002, 1004 for 1098 in FIG. 10; 1102, 1104 for 1198, 1152 in FIG. 11) and the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the second FOV may correspond to a periphery portion of the image data 1205 (e.g., 706 for 798 in FIG. 7; 806 for 898 in FIG. 8; 906 for 998 in FIG. 9; 1006 for 1098 in FIG. 10; 1102 for 1198, 1150 in FIG. 11). In such aspects, the display processor 1202, to blend the first FOV, may be configured to align (e.g., 822, 840 in FIG. 8; 922 in FIG. 9) a prior first FOV corresponding to a prior frame (e.g., frame n-1 in FIG. 7) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) with a full FOV reference frame (e.g., 814, 832 in FIG. 8; 914 in FIG. 9) of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) for the alignment (e.g., 822, 840 in FIG. 8; 922 in FIG. 9) based on a first set of offsets (e.g., [928, 930] in FIG. 9) associated with first fovea coordinates for the first FOV and a first scaling factor (e.g., 818, 836 in FIG. 8; 918 in FIG. 9), to warp (e.g., 736 in FIG. 7; 816, 834 in FIG. 8; 916 in FIG. 9) the aligned prior first FOV based on the full FOV reference frame (e.g., 814, 832 in FIG. 8; 914 in FIG. 9), and to align (e.g., 822, 840 in FIG. 8; 922 in FIG. 9) the warped, aligned prior first FOV (e.g., 824, 842 in FIG. 8; 924 in FIG. 9) with the full FOV reference frame (e.g., 814, 832 in FIG. 8; 914 in FIG. 9) based on a second set of offsets (e.g., [932, 934] in FIG. 9) associated with second fovea coordinates for the second FOV and a second scaling factor (e.g., 826, 844 in FIG. 8; 926 in FIG. 9).

In some aspects, the first FOV includes a first margin region (e.g., 1112 in FIG. 11) that surrounds the fovea portion and the prior first FOV includes a prior margin region (e.g., 1114 in FIG. 11) that surrounds a prior fovea portion. In such aspects, to blend the first FOV, the display processor 1202 may be configured to add, before the alignment (e.g., 822, 840 in FIG. 8; 922 in FIG. 9) of the prior first FOV, at least one of the first margin region (e.g., 1112 in FIG. 11) to the first FOV or the prior margin region (e.g., 1114 in FIG. 11) to the prior first FOV, and to remove, subsequent to the alignment (e.g., 822, 840 in FIG. 8; 922 in FIG. 9) of the warped, aligned prior first FOV (e.g., 824, 842 in FIG. 8; 924 in FIG. 9), at least one of the first margin region (e.g., 1112 in FIG. 11) from the first FOV or the prior margin region (e.g., 1114 in FIG. 11) from the prior first FOV. The first margin region (e.g., 1112 in FIG. 11) and/or the prior margin region (e.g., 1114 in FIG. 11) may be based on at least one of a full resolution of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), a maximum rate of gaze shift (e.g., 1012 in FIG. 10; 700°/sec in FIG. 11) per frame of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), a number of invalid pixels (e.g., 1014 in FIG. 10) associated with blending the first FOV, and/or the like.

In aspects for which the first FOV is a fovea FOV (e.g., 702 in FIG. 7; 802 in FIG. 8; 902 for 998 in FIG. 9; 1002, 1004 in FIG. 10; 1102, 1152 in FIG. 11) and the second FOV is a periphery FOV (e.g., 706 in FIG. 7; 806 in FIG. 8; 906 in FIG. 9; 1006 for 1098 in FIG. 10; 1106, 1150 in FIG. 11), to determine the second filtered output (e.g., 732 in FIG. 7), the display processor 1202 may be configured to divide the second FOV (e.g., 1150 in FIG. 11) into a second number of tiles (e.g., 1156, 1158, 1160 in FIG. 11), where each of the second number of tiles (e.g., 1156, 1158, 1160 in FIG. 11) is associated with a second unique ordered identifier (e.g., 1, 2, 3, 9, 10, 11, 17, 18, 19 in FIG. 11) of a set of second identifiers, and to determine the first filtered output (e.g., 730 in FIG. 7), the display processor 1202 may be configured to divide the first FOV (e.g., 1152 in FIG. 11) into a first number of tiles (e.g., 1162, 1164 in FIG. 11), where each of the first number of tiles (e.g., 1162, 1164 in FIG. 11) is associated with a first unique ordered identifier (e.g., 4, 5, 6, 7, 8, 12, 13, 14, 15, 16 in FIG. 11) of a set of first identifiers. In such aspects, a combination of the set of first identifiers and the set of second identifiers includes or may be a set of sequential ordered identifiers. To filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile until at least one second row (e.g., 1156 in FIG. 11) of the second number of tiles (e.g., 1156, 1158, 1160 in FIG. 11) are filtered tiles that surround at least one first row (e.g., 1162 in FIG. 11) of the first number of tiles (e.g., 1162, 1164 in FIG. 11) that are unfiltered, and to filter (e.g., 714, 716 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7), based on second resolution metadata (e.g., 1154 in FIG. 11) associated with the at least one second row (e.g., 1156 in FIG. 11) of the second number of tiles (e.g., 1156, 1158, 1160 in FIG. 11) that are the filtered tiles, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the first number of tiles (e.g., 1162, 1164 in FIG. 11) for the at least one first row (e.g., 1162 in FIG. 11) based on the first unique ordered identifier (e.g., 4, 5, 6, 7, 8, 12, 13, 14, 15, 16 in FIG. 11) associated with each tile in the at least one first row (e.g., 1162 in FIG. 11). In such aspects, to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile until the at least one second row (e.g., 1156 in FIG. 11) and at least one additional second row (e.g., 1158 in FIG. 11) of the second number of tiles (e.g., 1156, 1158, 1160 in FIG. 11) are the as filtered tiles that surround at least one additional first row (e.g., 1164 in FIG. 11) of the first number of tiles (e.g., 1162, 1164 in FIG. 11) that are unfiltered, and to filter (e.g., 714, 716 in FIG. 7) the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7), based on metadata (e.g., 1154 in FIG. 11) for the second resolution associated with one or more of the at least one second row (e.g., 1156 in FIG. 11) and the at least one additional second row (e.g., 1158 in FIG. 11) of the second number of tiles (e.g., 1156, 1158, 1160 in FIG. 11) that are filtered tiles, the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the first number of tiles (e.g., 1162, 1164 in FIG. 11) for the at least one additional first row (e.g., 1164 in FIG. 11) based on the first unique ordered identifier (e.g., 4, 5, 6, 7, 8, 12, 13, 14, 15, 16 in FIG. 11) associated with each tile in the at least one additional first row (e.g., 1164 in FIG. 11). In some aspects, to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together with the first portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11), the display processor 1202 may be configured to filter (e.g., 714, 716 in FIG. 7) the second portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) per tile of the second number of tiles (e.g., 1156, 1158, 1160 in FIG. 11) based on the second unique ordered identifier (e.g., 1, 2, 3, 9, 10, 11, 17, 18, 19 in FIG. 11) associated with each tile for a remaining set of unfiltered tiles (e.g., 1160 in FIG. 11) subsequent to filtering (e.g., 714, 716 in FIG. 7) all of the first number of tiles (e.g., 1162, 1164 in FIG. 11).

At 1416, the apparatus may determine a third filtered output corresponding to the third FOV at the third resolution by filtering the fourth portion of the image data and the fifth portion of the image data together. For example, referring to FIG. 12, display processor 1202 may also be configured to determine a third filtered output (e.g., 734 in FIG. 7) corresponding to the third FOV at the third resolution by filtering (e.g., 716 in FIG. 7) the fourth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) and the fifth portion of the image data 1205 (e.g., 702, 704, 706 for 798 in FIG. 7; 802, 806 for 898 in FIG. 8; 902, 906 for 998 in FIG. 9; 1002, 1004, 1006 for 1098 in FIG. 10; 1102, 1104, 1106 for 1198, 1150, 1152 in FIG. 11) together. In some aspects, to determine the first filtered output (e.g., 730 in FIG. 7) and to determine the second filtered output (e.g., 732 in FIG. 7), the display processor 1202 may be configured to determine the first filtered output (e.g., 730 in FIG. 7) and determining the second filtered output (e.g., 732 in FIG. 7) concurrently/at least partially concurrently via a first call to a NRT core (e.g., at 714 in FIG. 7), and to determine the third filtered output (e.g., 734 in FIG. 7), the display processor 1202 may be configured to determine the third filtered output (e.g., 734 in FIG. 7) via a second call to a second NRT core (e.g., at 716 in FIG. 7) that is different from the first call (e.g., 714 in FIG. 7). The first FOV may be a fovea FOV (e.g., 702 in FIG. 7; 802 in FIG. 8; 902 for 998 in FIG. 9; 1002, 1004 in FIG. 10; 1102, 1152 in FIG. 11), the second FOV may be a periphery FOV (e.g., 706 in FIG. 7; 806 in FIG. 8; 906 in FIG. 9; 1006 for 1098 in FIG. 10; 1106, 1150 in FIG. 11), and the third FOV may be a mid-fovea FOV (e.g., 704 in FIG. 7).

At 1418, the apparatus may output blended image data based on the first filtered output and the second filtered output. For example, referring to FIG. 12, the display processor 1202 may be configured to output blended image data 1214 based on the first filtered output (e.g., 730 in FIG. 7) and the second filtered output (e.g., 732 in FIG. 7). In aspects, to output the blended image data 1214, the display processor 1202 may be configured to output the blended image data 1214 based on the first filtered output (e.g., 730 in FIG. 7), the second filtered output (e.g., 732 in FIG. 7), and the third filtered output (e.g., 734 in FIG. 7). In aspects, the blended image data 1214 output by the display processor 1202 may be provided to the display panel 1204 and/or stored in a memory 1299. In some aspects, the display processor 1202 may be configured to output blended image data based on a merger of the outputs (e.g., 730, 732, 734 together in FIG. 7), and the merger of the outputs (e.g., 730, 732, 734 together in FIG. 7) may be performed via a compositor and/or the like.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for obtaining a first portion of image data at a first resolution, the first portion corresponding to a first FOV, for obtaining a second portion of the image data at a second resolution that is lower than the first resolution, the second portion of the image data corresponding to a second FOV, where the second FOV is larger than the first FOV and comprises the first FOV, for determining a first filtered output corresponding to the first FOV at the first resolution by filtering the first portion of the image data together with the second portion of the image data, for determining a second filtered output corresponding to the second FOV at the second resolution by filtering the second portion of the image data together with the first portion of the image data, and for outputting blended image data based on the first filtered output and the second filtered output. The apparatus may further include means for obtaining a third portion of the image data at a third resolution that is lower than the first resolution and the second resolution, the third portion of the image data corresponding to the second FOV. The apparatus may further include means for obtaining a fourth portion of the image data at a third resolution that is lower than the first resolution and higher than the second resolution, the fourth portion of the image data corresponding to a third FOV, where the third FOV is larger than the first FOV and comprises the first FOV and where the second FOV is larger than the third FOV and comprises the third FOV, for obtaining a fifth portion of the image data at a fourth resolution that is lower than the second resolution, the fifth portion of the image data corresponding to the second FOV, and for determining a third filtered output corresponding to the third FOV at the third resolution by filtering the fourth portion of the image data and the fifth portion of the image data together.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: obtaining a first portion of image data at a first resolution, the first portion corresponding to a first field of view (FOV); obtaining a second portion of the image data at a second resolution that is lower than the first resolution, the second portion of the image data corresponding to a second FOV, wherein the second FOV is larger than the first FOV and comprises the first FOV; determining a first filtered output corresponding to the first FOV at the first resolution by filtering the first portion of the image data together with the second portion of the image data; determining a second filtered output corresponding to the second FOV at the second resolution by filtering the second portion of the image data together with the first portion of the image data; and outputting blended image data based on the first filtered output and the second filtered output.

Aspect 2 is the method of aspect 1, further comprising: obtain a third portion of the image data at a third resolution that is lower than the first resolution and the second resolution, the third portion of the image data corresponding to the second FOV; wherein determining the first filtered output corresponding to the first FOV at the first resolution includes filtering the first portion of the image data, the second portion of the image data, and the third portion of the image data together; wherein determining the second filtered output corresponding to the second FOV at the second resolution includes filtering the second portion of the image data, the third portion of the image data, and the first portion of the image data together.

Aspect 3 is the method of aspect 2, wherein determining the first filtered output includes determining the first filtered output via a call to a non-real time (NRT) core; wherein determining the second filtered output includes determining the second filtered output via the call to the NRT core concurrently with the first filtered output.

Aspect 4 is the method of any of aspects 1 to 3, wherein the first FOV is a fovea FOV and the second FOV is a periphery FOV.

Aspect 5 is the method of any of aspects 1 to 4, further comprising: obtaining a fourth portion of the image data at a third resolution that is lower than the first resolution and higher than the second resolution, the fourth portion of the image data corresponding to a third FOV, wherein the third FOV is larger than the first FOV and comprises the first FOV and wherein the second FOV is larger than the third FOV and comprises the third FOV; obtaining a fifth portion of the image data at a fourth resolution that is lower than the second resolution, the fifth portion of the image data corresponding to the second FOV; and determining a third filtered output corresponding to the third FOV at the third resolution by filtering the fourth portion of the image data and the fifth portion of the image data together; wherein outputting the blended image data includes outputting the blended image data based on the first filtered output, the second filtered output, and the third filtered output.

Aspect 6 is the method of aspect 5, wherein determining the first filtered output and to determine the second filtered output includes determining the first filtered output and determining the second filtered output concurrently via a first call to a non-real time (NRT) core; wherein determining the third filtered output includes determining the third filtered output via a second call to a second NRT core that is different from the first call.

Aspect 7 is the method of any of aspects 5 and 6, wherein the first FOV is a fovea FOV, the second FOV is a periphery FOV, and the third FOV is a mid-fovea FOV.

Aspect 8 is the method of any of aspects 1 to 7, wherein filtering the first portion of the image data and the second portion of the image data together includes filtering based on spatio-temporal filtering and to blend the first FOV and the second FOV with a prior first FOV and a prior second FOV, respectively, based on at least one of an alignment or a warp associated with a prior frame of the image data with reference to a current frame of the image data.

Aspect 9 is the method of any of aspects 1 to 8, wherein the first portion of the image data and the first FOV correspond to a fovea portion of the image data and the second portion of the image data and the second FOV correspond to a periphery portion of the image data; wherein blending the first FOV includes: aligning a prior first FOV corresponding to a prior frame of the image data with a full FOV reference frame of the image data for the alignment based on a first set of offsets associated with first fovea coordinates for the first FOV and a first scaling factor; warping the aligned prior first FOV based on the full FOV reference frame; and aligning the warped, aligned prior first FOV with the full FOV reference frame based on a second set of offsets associated with second fovea coordinates for the second FOV and a second scaling factor.

Aspect 10 is the method of aspect 9, wherein the first FOV includes a first margin region that surrounds the fovea portion and the prior first FOV includes a prior margin region that surrounds a prior fovea portion; wherein blending the first FOV includes: adding, before the alignment of the prior first FOV, at least one of the first margin region to the first FOV or the prior margin region to the prior first FOV; and removing, subsequent to the alignment of the warped, aligned prior first FOV, at least one of the first margin region from the first FOV or the prior margin region from the prior first FOV.

Aspect 11 is the method of aspect 10, wherein a first size of the first margin region and a second size of the prior margin region are based on at least one of a full resolution of the image data, a maximum rate of gaze shift per frame of the image data, or a number of invalid pixels associated with blending the first FOV.

Aspect 12 is the method of any of aspects 1 to 11, wherein the first FOV is a fovea FOV and the second FOV is a periphery FOV; wherein determining the second filtered output includes: dividing the second FOV into a second number of tiles, wherein each of the second number of tiles is associated with a second unique ordered identifier of a set of second identifiers; wherein determining the first filtered output includes: dividing the first FOV into a first number of tiles, wherein each of the first number of tiles is associated with a first unique ordered identifier of a set of first identifiers; wherein a combination of the set of first identifiers and the set of second identifiers includes a set of sequential ordered identifiers.

Aspect 13 is the method of aspect 12, wherein filtering the second portion of the image data together with the first portion of the image data includes: filtering the second portion of the image data per tile of the second number of tiles based on the second unique ordered identifier associated with each tile until at least one second row of the second number of tiles are filtered tiles that surround at least one first row of the first number of tiles that are unfiltered; wherein filtering the first portion of the image data together with the second portion of the image data includes: filtering, based on second resolution metadata associated with the at least one second row of the second number of tiles that are the filtered tiles, the first portion of the image data per tile of the first number of tiles for the at least one first row based on the first unique ordered identifier associated with each tile in the at least one first row.

Aspect 14 is the method of aspect 13, wherein filtering the second portion of the image data together with the first portion of the image data includes: filtering the second portion of the image data per tile of the second number of tiles based on the second unique ordered identifier associated with each tile until the at least one second row and at least one additional second row of the second number of tiles are the filtered tiles that surround at least one additional first row of the first number of tiles that are unfiltered; wherein filtering the first portion of the image data together with the second portion of the image data includes: filtering, based on metadata for the second resolution associated with one or more of the at least one second row and the at least one additional second row of the second number of tiles that are the filtered tiles, the first portion of the image data per tile of the first number of tiles for the at least one additional first row based on the first unique ordered identifier associated with each tile in the at least one additional first row.

Aspect 15 is the method of aspect 14, wherein filtering the second portion of the image data together with the first portion of the image data includes: filtering the second portion of the image data per tile of the second number of tiles based on the second unique ordered identifier associated with each tile for a remaining set of unfiltered tiles subsequent to filtering all of the first number of tiles.

Aspect 16 is the method of any of aspects 1 to 15, wherein outputting the blended image data based on the first filtered output and the second filtered output includes at least one of: providing the blended image data for a display panel; or storing the blended image data in a memory.

Aspect 17 is an apparatus for display processing comprising a processor coupled to a memory and, based on information stored in the memory, the processor is configured to implement a method as in any of aspects 1-16.

Aspect 18 may be combined with aspect 17 and comprises that the apparatus is a wireless communication device.

Aspect 19 is an apparatus for display processing comprising means for implementing a method as in any of aspects 1-16.

Aspect 20 is a computer-readable medium (e.g., a non-transitory computer readable-medium) storing computer executable code, the computer executable code, when executed by a processor, causes the processor to implement a method as in any of aspects 1-16.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
obtain a first portion of image data at a first resolution, the first portion corresponding to a first field of view (FOV);
obtain a second portion of the image data at a second resolution that is lower than the first resolution, the second portion of the image data corresponding to a second FOV, wherein the second FOV is larger than the first FOV and comprises the first FOV;
determine a first filtered output corresponding to the first FOV at the first resolution by filtering the first portion of the image data together with the second portion of the image data;
determine a second filtered output corresponding to the second FOV at the second resolution by filtering the second portion of the image data together with the first portion of the image data; and
output blended image data based on the first filtered output and the second filtered output.

2. The apparatus of claim 1, wherein the processor is further configured to:
obtain a third portion of the image data at a third resolution that is lower than the first resolution and the second resolution, the third portion of the image data corresponding to the second FOV;
wherein to determine the first filtered output corresponding to the first FOV at the first resolution, the processor is configured to filter the first portion of the image data, the second portion of the image data, and the third portion of the image data together;
wherein to determine the second filtered output corresponding to the second FOV at the second resolution, the processor is configured to filter the second portion of the image data, the third portion of the image data, and the first portion of the image data together.

3. The apparatus of claim 2, wherein to determine the first filtered output, the processor is configured to determine the first filtered output via a call to a non-real time (NRT) core;
wherein to determine the second filtered output, the processor is configured to determine the second filtered output via the call to the NRT core concurrently with the first filtered output.

4. The apparatus of claim 1, wherein the first FOV is a fovea FOV and the second FOV is a periphery FOV.

5. The apparatus of claim 1, wherein the processor is further configured to:
obtain a fourth portion of the image data at a third resolution that is lower than the first resolution and higher than the second resolution, the fourth portion of the image data corresponding to a third FOV, wherein the third FOV is larger than the first FOV and comprises the first FOV and wherein the second FOV is larger than the third FOV and comprises the third FOV;
obtain a fifth portion of the image data at a fourth resolution that is lower than the second resolution, the fifth portion of the image data corresponding to the second FOV; and
determine a third filtered output corresponding to the third FOV at the third resolution by filtering the fourth portion of the image data and the fifth portion of the image data together;
wherein to output the blended image data, the processor is configured to output the blended image data based on the first filtered output, the second filtered output, and the third filtered output.

6. The apparatus of claim 5, wherein to determine the first filtered output and to determine the second filtered output, the processor is configured to determine the first filtered output and determining the second filtered output concurrently via a first call to a non-real time (NRT) core;
wherein to determine the third filtered output, the processor is configured to determine the third filtered output via a second call to a second NRT core that is different from the first call.

7. The apparatus of claim 5, wherein the first FOV is a fovea FOV, the second FOV is a periphery FOV, and the third FOV is a mid-fovea FOV.

8. The apparatus of claim 1, wherein to filter the first portion of the image data and the second portion of the image data together, the processor is configured to filter based on spatio-temporal filtering and to blend the first FOV and the second FOV with a prior first FOV and a prior second FOV, respectively, based on at least one of an alignment or a warp associated with a prior frame of the image data with reference to a current frame of the image data.

9. The apparatus of claim 1, wherein the first portion of the image data and the first FOV correspond to a fovea portion of the image data and the second portion of the image data and the second FOV correspond to a periphery portion of the image data;
wherein to blend the first FOV, the processor is configured to:
align a prior first FOV corresponding to a prior frame of the image data with a full FOV reference frame of the image data for the alignment based on a first set of offsets associated with first fovea coordinates for the first FOV and a first scaling factor;
warp the aligned prior first FOV based on the full FOV reference frame; and
align the warped, aligned prior first FOV with the full FOV reference frame based on a second set of offsets associated with second fovea coordinates for the second FOV and a second scaling factor.

10. The apparatus of claim 9, wherein the first FOV includes a first margin region that surrounds the fovea portion and the prior first FOV includes a prior margin region that surrounds a prior fovea portion;
wherein to blend the first FOV, the processor is configured to:
add, before the alignment of the prior first FOV, at least one of the first margin region to the first FOV or the prior margin region to the prior first FOV; and
remove, subsequent to the alignment of the warped, aligned prior first FOV, at least one of the first margin region from the first FOV or the prior margin region from the prior first FOV.

11. The apparatus of claim 10, wherein a first size of the first margin region and a second size of the prior margin region are based on at least one of a full resolution of the image data, a maximum rate of gaze shift per frame of the image data, or a number of invalid pixels associated with blending the first FOV.

12. The apparatus of claim 1, wherein the first FOV is a fovea FOV and the second FOV is a periphery FOV;
wherein to determine the second filtered output, the processor is configured to:
divide the second FOV into a second number of tiles, wherein each of the second number of tiles is associated with a second unique ordered identifier of a set of second identifiers;
wherein to determine the first filtered output, the processor is configured to:
divide the first FOV into a first number of tiles, wherein each of the first number of tiles is associated with a first unique ordered identifier of a set of first identifiers;
wherein a combination of the set of first identifiers and the set of second identifiers includes a set of sequential ordered identifiers.

13. The apparatus of claim 12, wherein to filter the second portion of the image data together with the first portion of the image data, the processor is configured to:
filter the second portion of the image data per tile of the second number of tiles based on the second unique ordered identifier associated with each tile until at least one second row of the second number of tiles are filtered tiles that surround at least one first row of the first number of tiles that are unfiltered;
wherein to filter the first portion of the image data together with the second portion of the image data, the processor is configured to:
filter, based on second resolution metadata associated with the at least one second row of the second number of tiles that are the filtered tiles, the first portion of the image data per tile of the first number of tiles for the at least one first row based on the first unique ordered identifier associated with each tile in the at least one first row.

14. The apparatus of claim 13, wherein to filter the second portion of the image data together with the first portion of the image data, the processor is configured to:
filter the second portion of the image data per tile of the second number of tiles based on the second unique ordered identifier associated with each tile until the at least one second row and at least one additional second row of the second number of tiles are the filtered tiles that surround at least one additional first row of the first number of tiles that are unfiltered;
wherein to filter the first portion of the image data together with the second portion of the image data, the processor is configured to:
filter, based on metadata for the second resolution associated with one or more of the at least one second row and the at least one additional second row of the second number of tiles that are the filtered tiles, the first portion of the image data per tile of the first number of tiles for the at least one additional first row based on the first unique ordered identifier associated with each tile in the at least one additional first row.

15. The apparatus of claim 14, wherein to filter the second portion of the image data together with the first portion of the image data, the processor is configured to:
filter the second portion of the image data per tile of the second number of tiles based on the second unique ordered identifier associated with each tile for a remaining set of unfiltered tiles subsequent to filtering all of the first number of tiles.

16. The apparatus of claim 1, wherein to output the blended image data based on the first filtered output and the second filtered output, the processor is configured to at least one of:
provide the blended image data for a display panel; or
store the blended image data in the memory.

17. The apparatus of claim 1, wherein the apparatus is a wireless communication device.

18. A method of display processing, comprising:
obtaining a first portion of image data at a first resolution, the first portion corresponding to a first field of view (FOV);
obtaining a second portion of the image data at a second resolution that is lower than the first resolution, the second portion of the image data corresponding to a second FOV, wherein the second FOV is larger than the first FOV and comprises the first FOV;
determining a first filtered output corresponding to the first FOV at the first resolution by filtering the first portion of the image data together with the second portion of the image data;
determining a second filtered output corresponding to the second FOV at the second resolution by filtering the second portion of the image data together with the first portion of the image data; and
outputting blended image data based on the first filtered output and the second filtered output.

19. The method of claim 18, further comprising:
obtaining a third portion of the image data at a third resolution that is lower than the first resolution and the second resolution, the third portion of the image data corresponding to the second FOV;
wherein determining the first filtered output corresponding to the first FOV at the first resolution includes filtering the first portion of the image data, the second portion of the image data, and the third portion of the image data together;
wherein determining the second filtered output corresponding to the second FOV at the second resolution includes filtering the second portion of the image data, the third portion of the image data, and the first portion of the image data together.

20. A computer-readable medium storing computer executable code, the computer executable code, when executed by a processor, causes the processor to:
obtain a first portion of image data at a first resolution, the first portion corresponding to a first field of view (FOV);
obtain a second portion of the image data at a second resolution that is lower than the first resolution, the second portion of the image data corresponding to a second FOV, wherein the second FOV is larger than the first FOV and comprises the first FOV;
determine a first filtered output corresponding to the first FOV at the first resolution by filtering the first portion of the image data together with the second portion of the image data;
determine a second filtered output corresponding to the second FOV at the second resolution by filtering the second portion of the image data together with the first portion of the image data; and
output blended image data based on the first filtered output and the second filtered output.
